(19) United States
(12) Patent Application Publication
(10) Pub. No.: US 2025/0016133 A1
(43) Pub. Date: Jan. 9, 2025

(54) SYSTEMS AND METHODS TO UNIQUELY IDENTIFY DEVICES

(71) Applicant: Comcast Cable Communications, LLC, Philadelphia, PA (US)

(72) Inventors: Albert RIBE COSTA, Palo Alto, CA (US); Ben Zion GABAY, Palo Ato, CA (US)

(21) Appl. No.: 18/347,388

(22) Filed: Jul. 5, 2023

(51) Int. Cl. H04L 61/5038

(52) U.S. Cl. CPC H04L 61/5038

(57) ABSTRACT

A server device may receive, from an application associated with a user device, a first user identifier associated with the user device and first information associated with the user device. The server device may receive, from a gateway device located at a premises associated with the user device, second information associated with an unidentified user device. The server device may store, based on a comparison of the first information associated with the user device and the second information associated with the unidentified user device, a second user identifier associated with the user device, wherein the comparison of the first information and the second information indicates the unidentified user device is the user device.

### BACKGROUND

Manufacturers of electronic devices typically include a hard-coded identification number on each electronic device. For example, manufacturers may produce electronic devices, such as user devices, that contain a unique media access control (MAC) address. Traditionally, MAC addresses were immutable and could be used to uniquely identify a particular electronic device. However, in recent years manufacturers have begun producing devices with MAC addresses that are not accessible, or MAC addresses that appear to change periodically. Thus, improvements are needed to allow for uniquely identifying user devices that have built-in identity obscuring mechanisms, for example MAC address randomization systems.

### SUMMARY

Systems, methods, and apparatuses are described herein for determining unique identities of devices, for example for determining unique identities of devices that use randomized MAC addresses. Whether a MAC address of a user device is cloaked or the MAC address changes over time, MAC addresses no longer reliably provide a unique identifier of a user device. Systems may require an ability to uniquely identify a user device to be able to provide necessary services to the user device. For example, systems may require an ability to uniquely identify a user device when the user device is in communication with a plurality of different networks. For example, a user may wish to know when a certain content consumption threshold is reached; for example, the user may wish to know when ten gigabytes of content has been consumed in a one-month period of time. However, to provide accurate services to user devices, the systems may need to rely on a new method for uniquely identifying user devices. A system may receive, at a server device and from an application associated with a user device, a first user identifier associated with the user device and first information associated with the user device. The system may receive, by the server device and from a gateway device located at a premises associated with the user device, second information associated with an unidentified user device. The server device may store, based on a comparison of the first information associated with the user device and the second information associated with the unidentified user device, a second user identifier associated with the user device, wherein the comparison of the first information and the second information indicates the unidentified user device is the user device. In this way, the system, comprising at least one of the server device, the application, and the gateway device, may determine a unique identifier of the user device based on one or more of a characteristic of the user device or data associated with the user device.

This summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of the disclosure.

### BRIEF DESCRIPTION OF THE DRAWINGS

The following detailed description is better understood when read in conjunction with the appended drawings, wherein like reference numbers refer to like elements throughout, unless specified otherwise. For the purposes of illustration, examples are shown in the drawings; however, the subject matter is not limited to specific elements and instrumentalities disclosed. In the drawings:

FIG. 1 shows an example system.

FIG. 2 shows an example method.

FIG. 3 shows an example method.

FIG. 4 shows an example method.

FIG. 5 shows an example method.

FIG. 6 shows an example method.

FIG. 7 shows an example method.

FIG. 8 shows an example method.

FIG. 9 shows an example method.

FIG. 10 shows an example method.

FIG. 11 shows an example computing system.

### DETAILED DESCRIPTION

Increasingly, devices, including mobile devices, laptop computers, personal digital assistants, and other portable devices may use methods for hiding their identities. For example, devices may hide their identities from applications associated with, or installed on, the devices, or the devices may hide their identities from networks or other devices the devices interact with. Manufacturers or other entities may associate a MAC address with a device as a unique identifier of the device. Therefore, learning a device's MAC address may be a simple and efficient way to determine a unique identifier associated with a device. However, there is an increasing desire to take efforts to hide the MAC address associated with a device. For example, users of user devices may wish to conceal the identity of their user devices, and the users of the user devices may wish to conceal the identity of the MAC addresses associated with their user devices. Additionally, some manufacturers may wish to conceal the identity of devices produced by the manufacturers, and the manufacturers may wish to conceal the MAC addresses associated with the devices produced by the manufacturers.

Devices may generate and store multiple randomized MAC addresses. For example, devices may be configured to present a randomized MAC address. The randomized MAC address may be presented by the device as the device's MAC address, but the randomized MAC address may be changed and/or change periodically from time to time. For example, the randomized MAC address may be randomized at certain intervals of time. For example, the randomized MAC addresses may be altered once per hour, once per day, once per week, once per month, or the like. Additionally, or alternatively, the randomized MAC address may be changed in response to a particular stimulus. For example, the device may generate a new randomized MAC address for each application or network the device interacts with. For example, the device may connect with a particular network, and the device may present a first randomized MAC address as the device's MAC address. The device may interact with an application, and the device may generate a second randomized MAC address to present to the application. Therefore, the device may be associated with different MAC addresses depending on what actions the device is taking or based on other devices or applications the device is interacting with. The device may store multiple randomized MAC addresses, or the device may only store a single randomized MAC address at a time. The devices may also generate randomized MAC addresses based on other criteria. For example, an application may be installed on a device at a first time, and the device may be associated with a first randomized MAC address at the first time. The application may determine the association of the device and the first randomized MAC address. At a second time, the device may generate a second randomized MAC address. The application may determine the device is associated with the second randomized MAC address and the application may update an indication of the device with the association of the second randomized MAC address. For example, a device may be initially associated with a first randomized MAC address when interacting with an application installed on the device. The application may be uninstalled from the device. The application may be reinstalled on the device. In response to reinstalling the application on the device, the device may generate a second randomized MAC address to present to the newly installed instance of the application on the device. Additionally, any of the known methods for randomizing a MAC address may be employed individually or in combination. For example, when a device interacts with an application for the first time, the device may generate a randomized MAC address associated with the device and associated with the application. The device may generate a new randomized MAC address associated with the application at a specified interval of time.

Therefore, it is becoming increasingly common for devices' MAC addresses to be unreliable unique identifiers. Thus, as it becomes less reliable to use a device's MAC address as a unique identifier, new systems and methods are required to uniquely identify devices. For example, users may wish for a system to notify a user when the user has consumed a particular quantity of content on a particular user device. For example, the user may wish to be notified when the user has consumed 90% of a maximum allowed quantity of content on the user device. For example, the user may be entitled to consume ten gigabytes of content per month on the user device via a particular network. The user may wish to be notified when the user has consumed 90% of the ten gigabytes of content during a particular month. However, without a reliable unique identifier for the user device, the content consumption tracking system may not be able to accurately determine a quantity of content consumed by the particular user device.

For example, when a user device is connected to one network, for example a home network, the user device may present the home network with a first randomized MAC address. When the user device is connected to a different network, for example an external network outside of the home network, the user device may present the external network with a second randomized MAC address. Therefore, if the system is unable to identify that the first randomized MAC address and the second randomized MAC address are associated with the same user device, the system may not be able to determine a totality of activities performed by the user device. For example, the system may determine the first randomized MAC address is associated with a first user device, and the system may determine the second randomized MAC address is associated with a second user device. Accordingly, it is desirable to determine a unique identifier that can be used to uniquely identify the user device, regardless of a randomized MAC address presented by the user device.

Systems and methods presented herein may provide a process for determining a unique identifier associated with a user device, and the unique identifier may be recognized by the system regardless of a MAC address or other information associated with the user device. For example, the system may determine a plurality of pieces of information associated with a user device and use at least one of the plurality of pieces of information to determine a unique identifier for the device. For example, the system may determine information associated with characteristics of the device. For example, the system, such as an application installed on a user device, may determine a device brand or a device model associated with the device. Though there may be thousands or even millions of devices with a same brand, model, or both, in combination with additional information, the system may determine a unique set of information associated with a particular device. Accordingly, the unique set of information, or at least some parts of the set of information may provide a unique identifier associated with the particular device.

A system described herein for producing a unique identifier associated with a device, such as a user device, may comprise any number of components. For example, the system may be associated with an application, for example an application on a user device. The application may be associated with a particular network or a particular service. The application may facilitate communication between the user device and the network. The application may facilitate the provision of services from the network to the user device. The application may be installed on the user device. Even though the application may be installed on the user device, the application may have limited access to information associated with the user device. For example, if the user device is a mobile phone, the application may not have access to phone calling capabilities, a list of contacts stored on the mobile phone, or any other particular information associated with the mobile phone. For example, the application may receive a MAC address from the mobile phone. The application may know the mobile phone or other user device employs a MAC randomization scheme. However, the application may not know the randomization scheme associated with the mobile phone or other user device. Accordingly, though the application may be associated with the particular network or the particular service, the particular network or the particular service may not know the randomization scheme associated with the mobile phone or other user device.

The application may be configured to determine a unique identifier associated with the user device. For example, the application may determine the user device employs MAC randomization and based on the determination the application may determine the unique identifier. The unique identifier may uniquely identify the user device regardless of a randomized MAC address sent by the user device. Accordingly, as the randomized MAC address changes for any reason, the system associated with the application may properly identify the user device based at least in part on the unique identifier.

The system may, additionally or alternatively, comprise a gateway device. For example, the gateway device may comprise a computing device. The gateway device may be located at a premises associated with the user device. The gateway device may be located at a premises associated with a user of the user device. The gateway device may comprise a network access point for accessing a network associated with the system. The gateway device may be configured to enable user devices at the premises to establish a wired or wireless connection to the network. The gateway device may establish a wired and/or wireless local area network, and the user devices may connect to the network via the local area network. For purposes of communicating wirelessly, the gateway device may implement a wireless access technology, such as the IEEE 802.11 (“Wi-fi”) radio access technology. In other implementations, other radio access technologies may be employed, such as IEEE 802.16 or 802.20 (“WiMAX”), IEEE 802.15.4a (“Zigbee”), or 802.15.3c (“UWB”). For purposes of communicating via a wired connection, the gateway device may be configured to implement a wired local area network technology, such as IEEE 802.3 (“Ethernet”), or the like.

The gateway device may comprise a router. The gateway device may comprise a modem. The gateway device may be configured to provide a first connection to a network via a service provider network, such as a network operated by a cable television system operator or other communications service provider. The service provider network may comprise any of a variety of types of networks, such as, for example, a coaxial cable network, a fiber-optic cable network, a hybrid fiber-coaxial (HFC) network, a satellite transmission channel, a DSL connection, or the like.

The gateway device may know the mobile phone or other user device associated with the user device employs MAC randomization. However, the gateway device may not know the randomization scheme associated with the mobile phone or user device. The gateway device may receive communications from the user device associated with the application. The gateway device may communicate with one or more server devices associated with a destination of the communication from the application. The one or more server devices may be associated with the application and the gateway device. The gateway device may receive information associated with the user device before, during, or after receiving the communication from the application. For example, the gateway device may receive a MAC address from the user device. The gateway device may receive a brand of the user device, a model of the user device, an operating system associated with the user device, or the like.

The gateway device may be configured to determine a unique identifier associated with the user device. For example, the gateway device may determine the user device employs MAC randomization and based on the determination the gateway device may determine the unique identifier. The unique identifier may uniquely identify the user device regardless of a randomized MAC address sent by the user device. Accordingly, as the randomized MAC address changes for any reason, the system associated with the gateway device may properly identify the user device based at least in part on the unique identifier.

The system may, additionally or alternatively, comprise one or more server devices. For example, the system may comprise one or more cloud server devices. The server devices may be located external to the premises associated with the user device, and the server devices may be configured to communicate with the user devices via a wired or wireless connection, for example via a wired or wireless connection associated with the gateway device. The server devices, for example the cloud servers, may store data associated with the user devices. For example, the server devices may store data received from a user device, including, but not limited to, data associated with activities performed by the user device, characteristics of the user device, or settings associated with the user device. The data received from the user device may be received directly from the user device. The data received from the user device may be received from an application associated with the system and further associated with the system. The server devices may store data received from the gateway device of the system. The gateway device may send information to the server devices. For example, the gateway device may send information associated with activities performed by the user device to the server devices. The gateway device may send information associated with a characteristic of the user device to the one or more server devices. The gateway device may send information associated with a setting or preference associated with the user device to the one or more server device.

The system may cause communication between any one of the application, the gateway device, or the one or more server devices to determine a unique identifier of a user device. The system may compare information determined by the application, information determined by the gateway device, or information received by the one or more server devices to determine a unique identifier associated with the user device. Thus, the system may determine a unique identifier associated with the user device, and the system may use the unique identifier to determine information associated with, and activities performed by, the user device. For example, the application may determine the unique identifier associated with the user device. The gateway device may determine the unique identifier associated with the user device. The one or more server devices may determine the unique identifier associated with the user device.

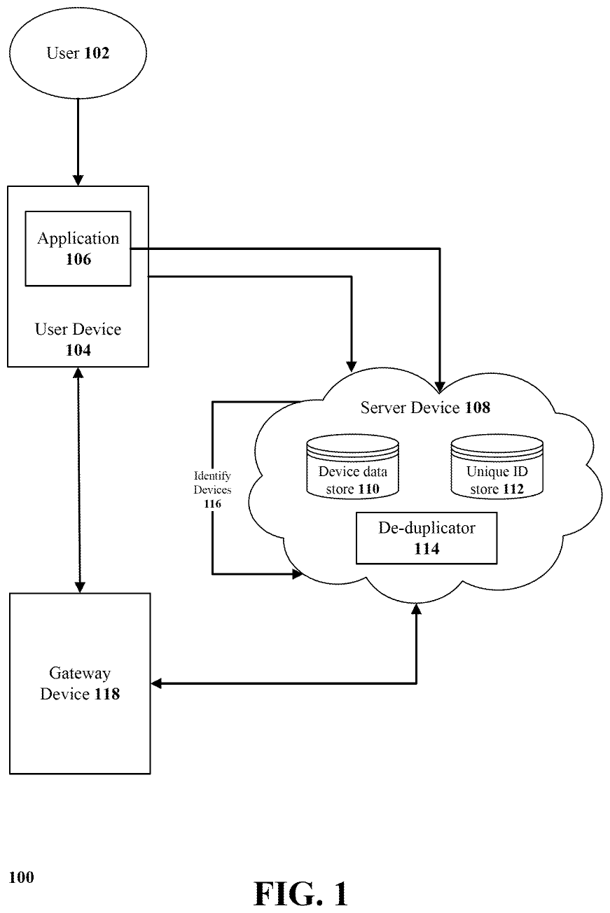

FIG. 1 shows an example system. The system may comprise a network and identification system for determining, based on a plurality of information, unique identifiers of user devices and identifying the user devices based on the unique identifiers. For example, the system may be able to identify a user device using the unique identifier, even when the user device is not actively connected to a network associated with the identification system. The unique identifier may be a particular identifier associated with the user device. The unique identifier may be associated with a plurality of pieces of information configured to uniquely identify the user device. The unique identifier may be a plurality of characters, for example a string of alphanumeric characters, or the like. As shown in FIG. 1, a user 102 may be associated with a user device 104. The user 102 and the user device 104 may be associated with a particular premises, such as a home of the user 102, a workplace of the user 102, or the like. The user device 104 may be a mobile phone, such as a cellular phone or smart phone, a personal digital assistant (PDA), a laptop computer, a set top box, a desktop computer, a tablet, or the like.

The user 102 may interact with the user device 104, such as performing searches, making phone calls, accessing networks or applications, or the like. The user device 104 may be associated with a particular set of characteristics. For example, the user device 104 may have a particular brand, model, trim, or other physically identifying features. The user device 104 may also, or alternatively, have characteristics related to the software associated with the user device 104. For example, the user device 104 may have a particular combination of applications installed on the user device 104, the user device 104 may use a specific operating system, the user device 104 may be associated with a particular internet protocol (IP) address, or the like. Furthermore, the user device 104 may comprise a randomized MAC address, such as a semi-permanent unique identifier or a limited unique identifier. A semi-permanent unique identifier may be a unique identifier associated with the user device 104 that may change periodically. For example, the semi-permanent unique identifier may change based on a passage of time, or the semi-permanent unique identifier may change based on a particular trigger. For example, the semi-permanent user identifier may change based on a determination whether the user device 104 is connected to a first network or a second network.

A limited unique identifier may be a unique identifier associated with the user device 104 that is only used in particular situations. For example, the user device 104 may determine a limited unique identifier for each application the user device 104 is associated with. For example, the user device 104 may be associated with the application 106, and the user device 104 may determine a limited unique identifier associated with the user device 104 and the application 106. For example, the user device 104 may be associated with a different application, and the user device 104 may determine a different limited unique identifier associated with the user device 104 and the different application. In this way, the user device 104 may still be uniquely identified when in communication with the application 106, however, the user device 104 may appear to be a different device when in communication with a different application. For example, the user device 104 may determine a first limited unique identifier, for example randomized MAC address ABCD associated with the application 106, and the user device 104 may determine a second limited unique identifier, for example randomized MAC address EFGH associated with a second application of the user device 104. Therefore, a network may receive information associated with randomized MAC address ABCD and the network may receive other information associated with randomized MAC address EFGH. In the absence of any other clarifying information, the network may determine device ABCD is different than device EFGH, when in reality, device ABCD and device EFGH are both associated with user device 104. The user device 104 may use the randomized MAC addresses, for example the semi-permanent unique identifier or the limited unique identifier to provide MAC randomization capabilities. For example, the user device 104 may send the semi-permanent unique identifier or the limited unique identifier to an application in place of a permanent MAC address of the user device 104. Thus, the user device 104 may withhold the user device's 104 permanent MAC address from the application.

The user device 104 may interact with the application 106, and the application 106 may retrieve an existing identifier associated with the user device 104, for example a randomized MAC address. For example, the existing identifier may be a semi-permanent unique identifier, or the existing identifier may be a limited unique identifier. The existing identifier may be sent to the server device 108. For example, the existing identifier may be sent to the server device 108 by the application 106. For example, the existing identifier may be associated with the application 106. The existing identifier may be associated with the user device 104. The existing identifier may be sent to the server device 108 by the user device 104. The existing identifier associated with the application 106 may be the same as the existing identifier associated with the user device 104. The existing identifier associated with the application 106 may be different from the existing identifier associated with the user device 104. Additionally, or alternatively, the application 106 may cause the user device 104 to generate a randomized identifier associated with the application 106. The randomized identifier may be associated with the application 106 in particular or the randomized identifier may be associated with additional applications as well as the application 106. The application 106 may cause the randomized identifier to be sent to the server device 108. For example, the randomized identifier may be a “universally unique identifier,” an “advertising identifier,” a “globally unique identifier,” a randomized MAC address, or any other type of randomized device identifier known in the art.

The application 106 may not initially be connected to a network associated with the system described herein. For example, the application 106 may not initially be connected to a home network associated with the user 102 or the user device 104 when initially installed on the user device 104. The application 106 may determine or retrieve the existing identifier, or the application 106 may generate the randomized identifier upon an initial association with the user device 104, and the application 106 may store the existing or randomized identifier for a first period of time. The user device 104 may connect to a network associated with the systems described herein. For example, the user device 104 may connect to a home network associated with the user 102 or the user device 104. The application 106 may send, to the server device 108, the existing or randomized identifier associated with the user device 104 upon connection with the home network. A home network may be a network associated with a default location associated with the user 102 or the user device 104, or both the user 102 and the user device 104. The application 106 may know the user device 104 employs MAC randomization. The application 106 may know the existing identifier or the randomized identifier may be associated with a randomized MAC address. The application 106 may determine a unique identifier associated with the user device 104. For example, the application 106 may determine the unique identifier based at least in part on determining the user device 104 uses MAC randomization. The application 106 may send, to the server device 108, the unique identifier.

The server device 108 may be associated with an external server or external server system. The server device 108 may be located external to the location associated with the home network, the user 102, the user device 108, or any combination of the three. The server device 108 may be a cloud server device or a cloud server system. The server device 108 may be configured to store information received from any number of networks, for example the home network associated with the user device 104. The server device 108 may be configured to receive information from the application 106, the user device 104, the gateway device 118, or any other device associated with the home network.

The server device 108 may be configured with a device data store 110. For example, the server device 108 may comprise at least one database, and the database may store data associated with the device. The device data store 110 may comprise an individual server device, a plurality of server devices, or portions of databases associated with a plurality of server devices, including server device 108. The device data store 110 may store data received from the application 106. The device data store 110 may store data received from the user device 104. For example, the device data store 110 may store an existing or randomized identifier received by the server device 108. For example, the device data store 110 may store information associated with the user device 104. For example, the user device 104 may be associated with a particular set of characteristics. The user device 104 may have a particular brand, model, trim, or other physically identifying features. The user device 104 may also, or alternatively, have characteristics related to the software associated with the user device 104. For example, the user device 104 may have a particular combination of applications installed on the user device 104, the user device 104 may use a specific operating system, the user device 104 may be associated with a particular internet protocol (IP) address, or the like. The information associated with the user device 104, such as the IP address, the brand, or the model of the user device 104 may be stored at the device data store 110.

The server device 108 may be configured with a unique ID store 112. For example, the server device 108 may, as described herein, determine a unique identifier (ID) that can be used to determine an identity of a device, such as user device 104, at any network. The server device 108 may cause the unique ID to be generated in response to data associated with the user device 104 received by the server device 108. The unique ID may be stored at the unique ID store 112. The unique ID store 112 may comprise at least one database, and the database may store the unique ID associated with the device. The unique ID store 112 may comprise an individual server device, a plurality of server devices, or portions of databases associated with a plurality of server devices, including server device 108. The unique ID store 112 may store any number of unique ID's associated with any number of user devices, for example user device 104. The unique ID store 112 may be configured to store multiple unique ID's associated with a single user device, for example user device 104.

The server device 108 may be configured with a de-duplicator 114. For example, the de-duplicator may be a process, device, or combination of devices associated with the server device 108. The de-duplicator 114 may serve to reduce the existence of redundant or additional unique user devices. For example, the unique ID store 112 may store a unique ID associated with the user device 104. The unique ID may be determined, based at least in part, on information received from application 106. The unique ID may be further based on any number of information or characteristics associated with the user device 104. For example, the unique ID may be determined based on an existing unique identifier associated with the user device 104. For example, the application 106, upon association with the user device 104, may determine a unique identifier generated by the user device 104 when the user device 104 is associated with a first, home network. Thus the new unique ID may comprise an indication associated with the unique identifier generated by the user device 104 in associated with the home network. However, the user device 104 may also generate a different unique ID when the user device 104 is associated with a second, non-home network. For example, when the user device 104 is located away from the home network, the user device 104 may generate a different unique ID than the unique ID associated with the home network. Therefore, the user device 104 may be associated with multiple unique ID's.

The unique ID store 112 may store a unique ID, generated by the server device 108, associated with the user device 104, based at least in part on the previously generated randomized MAC addresses received at the server device 108. However, as noted previously, the user device 104 may generate multiple different randomized MAC addresses. Therefore, the server device 108 may generate multiple device profiles, and the multiple device profiles may be stored at the unique ID store 112. Because the process of generating, by the user device 104, randomized MAC addresses may occur tens, hundreds, or more times over the course of a user device's 104 lifespan, the server device 108 may generate tens, hundreds, or more device profiles associated with the user device 104. Therefore, there is a concern that the unique ID store 112 may require much more space than necessary to store redundant device profiles associated with a same user device 104.

The de-duplicator 114 may determine any number of device profiles that are associated with the same device, such as user device 104, and the de-duplicator 114 may remove the duplicate entries from the unique ID store 112. Though the different randomized MAC addresses generated by the user device 104 may each be different, some or all of the information associated with the device profiles may be the same or substantially similar across all or most of the device profiles associated with the same user device 104. For example, each one of the device profiles may be associated with characteristics of the user device 104, for example an IP address, a brand, or a model of the user device 104. Therefore, even though multiple different device profiles may be generated for the user device 104, the IP address, brand, and model of the user device 104 may be similar, or the same, across substantially all of the device profiles. The de-duplicator 114 may determine a threshold similarity between the information associated with multiple device profiles stored at the unique ID store 112, and the de-duplicator may determine, based on the threshold similarity, the multiple device profiles are associated with the same user device, such as user device 104. The de-duplicator 114 may remove from the unique ID store 112, some, all, or all but one of the device profiles associated with the same user device 104. Though the de-duplicator 114 is described with reference to actions taken in response to information and device profiles stored on the unique ID store 112, the de-duplicator 114 may additionally, or alternatively, take the same actions with relation to the device data store 110, for example determining duplicate entries of device data corresponding to the same user device 104, and removing some, all, or all but one of the duplicate entries.

A gateway device 118 may be configured to communicate with the user device 104 and the server device 108. For example, the gateway device 118 may comprise a computing device. The gateway device 118 may be located at a premises associated with the user device 104. The gateway device 118 may be located at a premises associated with a user 102. The gateway device 118 may comprise a network access point for accessing a network associated with the system. The gateway device 118 may be configured to enable user devices at the premises to establish a wired or wireless connection to the network. The gateway device 118 may establish a wired and/or wireless local area network, and the user devices may connect to the network via the local area network. The gateway device 118 may comprise a router. The gateway device 118 may comprise a modem. The gateway device 118 may be configured to provide a first connection to a network via a service provider network, such as a network operated by a cable television system operator or other communications service provider.

The gateway device 118 may be configured to communicate with the user device 104 to provide access to the server device 108, or to the provide access to a network, such as the internet, for example. The gateway device may be associated with a home network of the user device 104. The gateway device 118 may receive queries, data, or other information from the user device 104, and the gateway device may determine one or more features associated with the user device 104 based on receiving the queries, data, or other information from the user device 104. For example, the gateway device 118 may receive a query from the user device 104, and the gateway device 118 may determine, based on information received during the query, at least one characteristic of the user device 104. For example, the gateway device 118 may receive a query from the user device 104, and the gateway device 118 may determine an IP address associated with the user device 104. The gateway device 118 may store the information received from the user device 104 and the information determined about the user device 104. The gateway device 118 may send to the server device 108, at least a portion of the information received from, or determined about, the user device 104. For example, the gateway device 118 may send, to the server device 108, an IP address associated with the user device 104, a brand of the user device 104, or a model of the user device 104. The server device 108 may store, at the device data store 110, the information received from the gateway device 118.

The server device 108 may, based on some or all of the information received from the application 106, the user device 104, and the gateway device 118, generate a unique ID for the user device 104. For example, the server device 108 may generate a unique identifier associated with the user device 104.

The server device 108 may determine, based on a comparison of the existing ID received from the application 106, the information received from the user device 104 or the application 106, and the information received from the gateway device 118, a particular set of information associated with an individual user device, such as user device 104. Thus, the server device 108, at step 116, may identify a user device, such as user device 104, based on a correlation of the set of information received from the application 106, the user device 104, and the gateway device 118. The server device 108 may store an indication of at least some of the correlated information to generate a unique set of information associated with the user device 104. The unique set of information may act as a fingerprint of the user device 104. For example, if the fingerprint comprises a brand and model of the user device and an IP address of the user device 104, the user device 104 may be identifiable based on receiving, by the server device 108, a request from an unknown device comprising the unique set of information comprising the brand and model of the user device 104 and the IP address of the user device 104. Though there may be multiple devices with the same brand, model, and IP address, the disclosure herein contemplates any number of characteristics associated with a user device that may, in combination, provide a unique set of information, or fingerprint, associated with a user device. The server device 108 may know the user device 104 is associated with a randomized MAC address. The server device 108 may determine the unique identifier associated with the user device 104. The server device 108 may determine the unique identifier associated with the user device 104 based at least in part on determining the user device 104 is associated with a randomized MAC address. The server device 108 may receive the unique identifier from at least one of an application 106 associated with the user device 104 or from the gateway device 118. The server device 108 may store the unique identifier associated with the user device 104 to uniquely identify the user device 104. For example, the server device 108 may receive data from an unknown device. The server device 108 may receive the unique identifier with the data, and the server device 108 may determine the unknown device is the user device 104.

Based on identifying the device 116 and determining the unique ID associated with the user device 104, the server device 108 may determine the user device 104 is associated with a query by an unknown device received from an unknown network. Thus, even though an existing ID for a user device 104 may vary from network to network, or from application to application, the server device 108 may retrieve the unique identifier associated with the user device 104 from the unique ID store 112 to decipher an identity of a user device 104. Accordingly, the server device 108 can correlate queries, data consumption, or any other interactions with a user device 104 across any number of networks and with any number of applications.

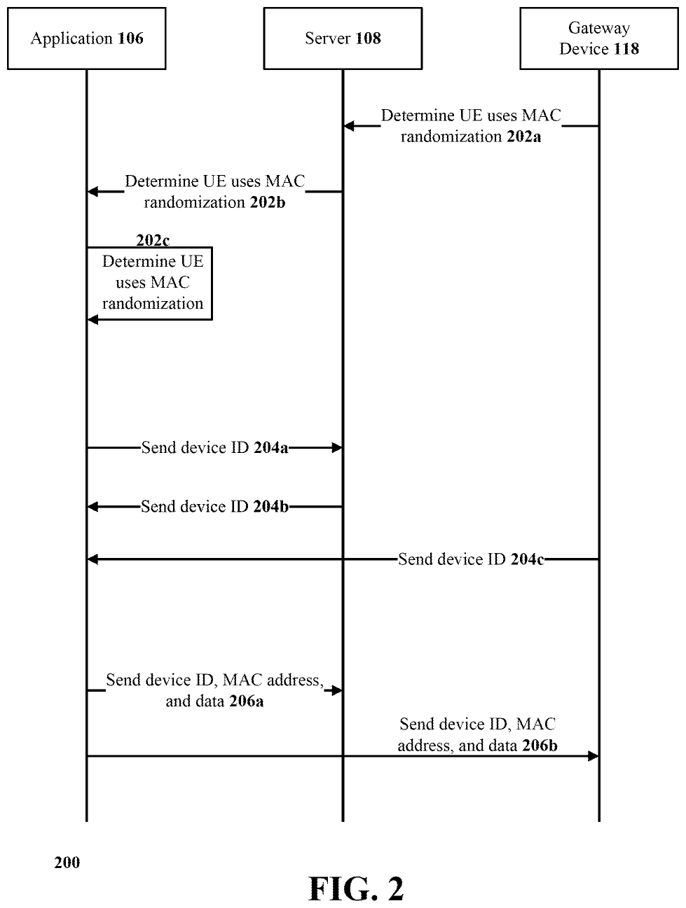

FIG. 2 shows an example method. The method may be used for determining a unique ID of a user device associated with a network, and the determined unique ID may be used to identify the user device, for example the unique ID may be used to identify the user device when the user device is associated with an unknown network. The user device may be configured to randomize its MAC address. The unique ID may be used to identify the user device regardless of the randomized MAC address determined by the user device. The method of FIG. 2 may be performed in connection with the system of FIG. 1. For example, the method may comprise steps performed among the application 106, the server 108, and the gateway device 118 of the system of FIG. 1. The application 106 and the gateway device 118 may communicate with, and send information to, the server 108, and the server 108 may determine, based on the received information associated with a user device, such as user device 104, a unique ID for the user device. One or more of steps 202a. 202b, and 202c may be performed. For example, one of steps 202a. 202b, and 202c may be performed, two of steps 202a. 202b, and 202c may be performed, or all of steps 202a. 202b, and 202c may be performed. One or more of steps 204a. 204b, and 204c may be performed. For example, one of steps 204a. 204b, and 204c may be performed, two of steps 204a. 204b, and 204c may be performed, or all of steps 204a. 204b, and 204c may be performed. One or more of steps 206a and 206b may be performed, For example, one of steps 206a and 206b may be performed or both of steps 206a and 206b may be performed.

At step 202a, the gateway device 118 may determine and send, to the server 108, an indication that the user device uses a MAC randomization scheme. The gateway device 118 may collect data associated with at least one user device. For example, the gateway device 118 may collect data from a single user device. The gateway device 118 may collect data associated with a plurality of user devices. The gateway device 118 may be associated with a network at a premises, such as a home network of a user device. The gateway device 118 may collect data associated with the user device at the user device's home network. For example, the user device may send a query or a request to the gateway device 118. The query or request may comprise a query for the network. The gateway device 118 may pass along the request in the network, and the gateway device 118 may determine and store information associated with the request and information associated with the user device sending the request. For example, the gateway device 118 may store the query made by the user device, the gateway device 118 may store a characteristic of the user device, the gateway device 118 may store a setting or preference of the user device, or the like. For example, the gateway device 118 may determine an IP address, a brand, and a model associated with a user device making the request. The gateway device 118 may store the IP address, the brand, the model, or any combination of the three. The gateway device 118 may determine the user device is configured to use a MAC randomization scheme. The gateway device 118 may store an indication that the user device is configured to use the MAC randomization scheme. The gateway device 118 may send the indication, the IP address, the brand, the model, or any combination to the server 108 at step 202a. The gateway device 118 may not know an identity of the user device at the time of sending the information to the server 108.

At step 202b, the server 108 may determine and send, to an application 106 associated with a user device, an indication that the user device uses a MAC randomization scheme. The server 108 may collect data associated with at least one user device. For example, the server 108 may collect data from a single user device. The server 108 may collect data associated with a plurality of user devices. The server 108 may be associated with a network at a premises, such as a home network of a user device. The server 108 may collect data associated with the user device at the user device's home network. For example, the user device may send a query or a request to the server 108. The query or request may comprise a query for the network. The server 108 may pass along the request in the network, and the server 108 may determine and store information associated with the request and information associated with the user device sending the request. For example, the server 108 may store the query made by the user device, the server 108 may store a characteristic of the user device, the server 108 may store a setting or preference of the user device, or the like. For example, the server 108 may determine an IP address, a brand, and a model associated with a user device making the request. The server 108 may store the IP address, the brand, the model, or any combination of the three. The server 108 may determine the user device is configured to use a MAC randomization scheme. The server 108 may store an indication that the user device is configured to use the MAC randomization scheme. The server 108 may send the indication, the IP address, the brand, the model, or any combination to the application 106 at step 202b. The server 108 may not know an identity of the user device at the time of sending the information to the application 106.

At step 202c, the application 106 may be associated with a user device. The application 106 may determine and send, to at least one of a server 108 or a gateway device 118, an indication that the user device uses a MAC randomization scheme. The application 106 may collect data associated with at least one user device. For example, the application 106 may collect data from a single user device. The application 106 may be installed on a plurality of user devices and the application 106 may collect data associated with the plurality of user devices. The application 106 may be associated with a network at a premises, such as a home network of a user device. The application 106 may collect data associated with the user device at the user device's home network. For example, the user device may send a query or a request to the application 106. The query or request may comprise a query for the network. The application 106 may pass along the request in the network, and the application 106 may determine and store information associated with the request and information associated with the user device sending the request. For example, the application 106 may store the query made by the user device, the application 106 may store a characteristic of the user device, the application 106 may store a setting or preference of the user device, or the like. For example, the application 106 may determine an IP address, a brand, and a model associated with a user device making the request. The application 106 may store the IP address, the brand, the model, or any combination of the three. The application 106 may determine the user device is configured to use a MAC randomization scheme. The application 106 may store an indication that the user device is configured to use the MAC randomization scheme. The application 106 may send the indication, the IP address, the brand, the model, or any combination to at least one of the server 108 or the gateway device 118 at step 202c.

At step 204a, an application 106 may send a device ID to the server 108. The device ID may be generated by the application 106, and the application 106 may associate the device ID with the user device. The device ID may be a persistent ID associated with the user device. The application 106 may generate the device ID upon being installed on the user device. The unique ID may uniquely identify the user device, but the unique ID may only be used in conjunction with the application 106. Even when the user device, configured to implement a MAC randomization scheme, changes a MAC address associated with the application 106, based on, for example a specific time period, or during a specific circumstance, the unique ID may uniquely identify the user device. For example, the user device may be configured to generate a randomized ID that may uniquely identify the user device while the randomized ID is active, but the randomized ID may only be associated with the application 106 for a period of one day, one week, one month, or any other time period. Additionally, or alternatively, the randomized ID may only be used between the user device and the application 106. For example, the application 106 may always have access to the randomized ID when in communication with the user device, so the application 106 may be able to determine when the application 106 is in communication with the user device. However, the user device may use a different randomized ID when interacting with a different application. Thus, a third party, such as a network or server, such as server 108, may not be able to use the randomized ID received from the application 106 to uniquely identify the user device outside of the time when the randomized ID is specifically in use. The application 106 may send the unique ID each time the application 106 sends data, for example packets, so the unique ID may be used to uniquely identify the user device, regardless of the randomized MAC.

At step 204b, a server 108 may send a device ID to the application 106. The device ID may be generated by the server 108, and the server 108 may associate the device ID with the user device. The device ID may be a persistent ID associated with the user device. The server 108 may generate the device ID upon determining the application 106 is installed on the user device. The unique ID may uniquely identify the user device, but the unique ID may only be used in conjunction with the application 106. Even when the user device, configured to implement a MAC randomization scheme, changes a MAC address associated with the application 106, based on, for example after a specific time period, or during a specific circumstance, the unique ID may uniquely identify the user device. For example, the user device may be configured to generate a randomized ID that may uniquely identify the user device while the randomized ID is active, but the randomized ID may only be associated with the application 106 for a period of one day, one week, one month, or any other time period. Additionally, or alternatively, the randomized ID may only be used between the user device and the application 106. For example, the server 108 may always have access to the randomized ID when in communication with the user device, so the server 108 may be able to determine when the server 108 is in communication with the user device. However, the user device may use a different randomized ID when interacting with a different application or server. Thus, a third party, such as a network or server, such as a server different than server 108, may not be able to use the randomized ID received from the application 106 to uniquely identify the user device outside of the time when the randomized ID is specifically in use. The server 108 may receive the unique ID each time the server 108 receives data from the user device, for example packets, so the unique ID may be used to uniquely identify the user device, regardless of the randomized MAC.

At step 204c, a gateway device 118 may send a device ID to the application 106. The device ID may be generated by the gateway device 118, and the gateway device 118 may associate the device ID with the user device. The device ID may be a persistent ID associated with the user device. The gateway device 118 may generate the device ID upon determining the application 106 is installed on the user device. The unique ID may uniquely identify the user device, but the unique ID may only be used in conjunction with the application 106. Even when the user device, configured to implement a MAC randomization scheme, changes a MAC address associated with the application 106, based on, for example after a specific time period, or during a specific circumstance, the unique ID may uniquely identify the user device. For example, the user device may be configured to generate a randomized ID that may uniquely identify the user device while the randomized ID is active, but the randomized ID may only be associated with the application 106 for a period of one day, one week, one month, or any other time period. Additionally, or alternatively, the randomized ID may only be used between the user device and the application 106. For example, the gateway device 118 may always have access to the randomized ID when in communication with the user device, so the gateway device 118 may be able to determine when the gateway device 118 is in communication with the user device. However, the user device may use a different randomized ID when interacting with a different application or server. Thus, a third party, such as a network or server, such as a gateway device different than gateway device 118, may not be able to use the randomized ID received from the application 106 to uniquely identify the user device outside of the time when the randomized ID is specifically in use. The gateway device 118 may receive the unique ID each time the gateway device 118 receives data from the user device, for example packets, so the unique ID may be used to uniquely identify the user device, regardless of the randomized MAC.

The application 106 may send, to the server 108, second device data associated with the user device 104. For example, the application 106 may send data associated with a characteristic of the user device to the server 108. For example, the application 106 may send data associated with a setting or a preference of the user device to the server 108. The application 106 may store a setting or preference of the user device, or the like. For example, the application 106 may determine an IP address, a brand, and a model associated with a user device making the request. The application 106 may store the IP address, the brand, the model, or any combination of the three. The application 106 may send the IP address, the brand, the model, or any combination of the three to the server 108. The application 106 may determine the user device 104 uses MAC randomization to determine or use randomized MAC addresses. The application 106 may cause the creation of a unique identifier, for example the device ID. The application 106 may send, to the server 108, the device ID. The application may send, to the gateway device 118, the device ID. The application 106 may send the device ID in connection with any or all communications with the system described herein.

At least one of the server 108 or the gateway device 118 may associate the device ID and device data associated with the user device. The device ID and the device data associated with the user device may be received by the server 108 or the gateway device 118.

At least one of the application 106, the server 108, or the gateway device 118 may generate the device ID. The device ID may be an ID that can be used to uniquely identify the user device outside a home network, at any network, after the user device randomizes a MAC address associated with the user device, or the like. Based on the device ID, the device may be recognized when joining a home network associated with the gateway device 118, the server 108, and the application 106, but the user device may also be recognized by the system when joining a different network, such as a wireless LTE network, a wireless 5G network, a different wireless network, a different wired network than the home network, or the like. For example, the application 106 may send the device ID along with other data each time the application 106 sends data to at least one of the gateway device 118 or the server 108. Therefore, the server 108 or the gateway device 118 may recognize the device ID and determine the identity of the user device based on receiving the device ID.

At step 206a, the application 106 may store the device ID at the application 106 or at the user device, or the like. The application 106 may use the device ID when communicating with other entities, for example the application 106 may use the device ID when communicating with the server 108. The application 106 may send a message to the server 108 and the message may comprise data, for example a query, and the message may comprise a MAC address and the device ID. The server 108 may be configured to recognize the device ID, and the server 108 may be configured to ignore the MAC address received from the application 106 and associated with the user device. For example, the server 108 may be configured to ignore, based on receiving the device ID, the randomized MAC address associated with the user device.

At step 206b, the application 106 may store the device ID at the application 106 or at the user device, or the like. The application 106 may use the device ID when communicating with other entities, for example the application 106 may use the device ID when communicating with the gateway device 118. The application 106 may send a message to the gateway device 118 and the message may comprise data, for example a query, and the message may comprise a MAC address and the device ID. The gateway device 118 may be configured to recognize the device ID, and the gateway device 118 may be configured to ignore the MAC address received from the application 106 and associated with the user device. For example, the gateway device 118 may be configured to ignore, based on receiving the device ID, the randomized MAC address associated with the user device.

The server 108 may receive, from the application 106, a message comprising the device ID. The server 108 may receive, from the application 106, a MAC address as part of the message. For example the server 108 may receive a randomized MAC address associated with the user device. The server 108 may receive both the device ID and the MAC address associated with the application 106. For example, the application 106 may be configured to send the device ID each time the application 106 sends data. The server 108 may use the device ID to determine an identity of the device sending the device ID and the MAC address. The server 108 may forego using the MAC address to determine an identity of the device sending the device ID and the MAC address.

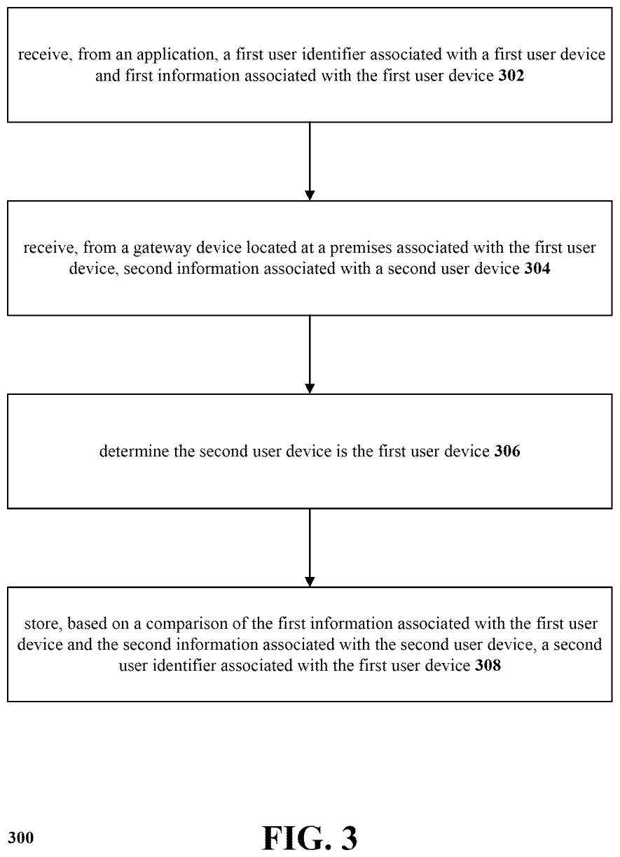

FIG. 3 shows an example method. The method described in FIG. 3 may be used by a system, for example by a communications service provider, to determine a unique identifier of a user device that may uniquely identify the user device over a plurality of different networks. For example, the method of FIG. 3 may be implemented by the system described in FIG. 1. The method of FIG. 3 may be performed, for example, by one or more of the user device 104, the application 106, the server device 108, or the gateway device 118 of the system of FIG. 1. For example, the method may take place, at least in part at a location associated with a network, such as a home network, or at a cloud server system.

At step 302, the system may receive, from an application, such as application 106, a first user identifier associated with a user device, such as user device 104, and first information associated with the user device. For example, the first user identifier may be a MAC address, for example a randomized MAC address. The first user identifier, such as a randomized MAC address, may be received by the system from the user device. For example, the user device may generate the first user identifier and send the first user identifier to the system. For example, the first information may comprise at least one of a characteristic of the user device, a setting of the user device, or an action performed by the user device. For example, the characteristic may be one or more of an IP address, a brand, or a model associated with the user device.

At step 304, the system may receive, from a gateway device, such as gateway device 118, located at a premises associated with the user device, second information associated with an unidentified user device. For example, the gateway device may be configured to operate at the premises to provide access to a network. For example, the gateway device may provide access, for a user device at the premises, to a wireless network or a wired network, or both, associated with the gateway device. The gateway device may receive information from one or more unidentified user devices. For example, the gateway device may not have a capability to determine an identity of a user device communicating with the gateway device, or the gateway device may not know an identity of the user device in communication with the gateway device. The gateway device may determine one or pieces of information about a user device interacting with the gateway device. For example, the gateway device may determine a characteristic, a setting, or a behavior associated with the user device. The gateway device may send, to a server device, such as server device 108, located remote from the premises, the data associated with the unidentified user device. For example, the gateway device may send the unidentified characteristic, setting, or behavior of the user device to the server device.

At step 306, the server device, for example server device 108, may determine the unidentified user device associated with the unidentified user device data received from the gateway device in step 304 is a same user device as the device associated with the information received from the application in step 302. For example, the server device may perform a comparison of the user device data and a unique user ID associated with the data received from the application in step 302, with the unidentified user device data received from the gateway device in step 304. The server device may determine a threshold similarity between the two devices, and the server device may determine the user device associated with the unique ID is the same device as the unidentified user device. For example, the server device may compare the characteristic, the setting, the behavior, or any other information received about the user device and the unidentified user device. The server device may determine each piece of compared information is the same. The server device may determine a threshold number of the pieces of information are the same. For example, the server device may determine that the IP address, the brand, and the model associated with the user device are the same as the IP address, the brand, and the model associated with the unidentified user device.

At step 308, the system may store, based on a comparison of the first information associated with the user device and the second information associated with the unidentified user device, a second user identifier associated with the user device. Based on the comparison of the information associated with the user device with the information associated with the unidentified user device exceeding a threshold similarity, the server device may determine the unidentified user device is the user device. Accordingly, the server device may store some or all of the information about the user device and the unidentified user device at a particular location at the server device. The server device may generate, using at least part of the user device information and the unidentified device information, the second user ID associated with the user device.

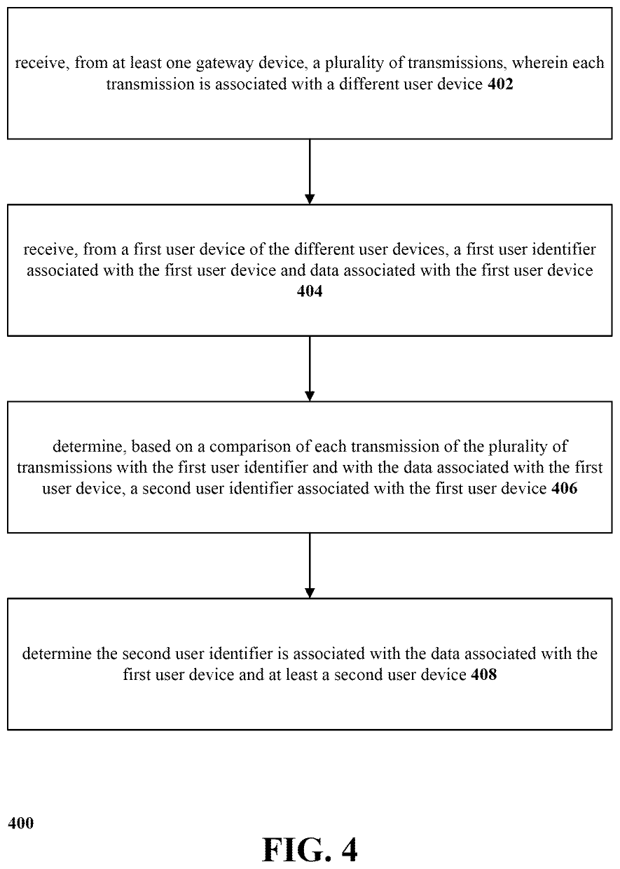

FIG. 4 shows an example method. The method described in FIG. 4 may be used by a system, for example by a communications service provider, to determine a unique identifier of a user device, of a plurality of user devices, that may uniquely identify the user device over a plurality of different networks. For example, the method of FIG. 4 may be implemented by the system described in FIG. 1. The method of FIG. 4 may be performed, for example, by one or more of the user device 104, the application 106, the server device 108, or the gateway device 118 of the system 100 of FIG. 1. For example, the method may take place, at least in part at a location associated with a network, such as a home network, or at a cloud server system.

At step 402, the system may receive, from at least one gateway device, such as gateway device 118, a plurality of transmissions, wherein each transmission is associated with a different unidentified user device. The gateway device may be located at a premises, and a server device associated with the system may be located external to the premises. Each one of the transmissions may arrive at the server device at a substantially similar time, some of the transmissions may arrive at the server device at a substantially similar time, or each one of the transmission may arrive at a different time. The server device may receive multiple different transmissions associated with a single unidentified user device, and the multiple different transmissions associated with the single unidentified user device may arrive at the same time or at different times.

At step 404, the server device may receive, from a particular user device, such as user device 104, a first user identifier associated with the user device and data associated with the user device. For example, the first user identifier may be a unique identifier for use in a limited set of circumstances. For example, the unique identifier may change periodically, the unique identifier may change based on a trigger condition, for example the trigger condition may be a factory reset of the user device, or the unique identifier may only be associated with a particular application, for example application 106. The server device may receive the data associated with the user device, and the data associated with the user device may comprise one or more of a characteristic, a setting, or a behavior of the user device. For example, the data associated with the user device may comprise an IP address, a brand, or a model of the user device.

At step 406, the server device may determine, based on a comparison of each transmission of the plurality of transmission with the first user identifier and with the data associated with the user device, a second user identifier associated with the user device. For example, the data associated with the user device may comprise the IP address, the brand, the model, or the like, of the user device. The server device may compare at least one of the pieces of data associated with the user device with one or more of the plurality of transmissions. Based on the comparison, the server device may determine at least one transmission from the gateway device associated with the data associated with the user device. For example, the server device may determine a single transmission from the gateway device associated with the user device. For example, the server device may determine more than one of the plurality of transmissions associated with the user device.

At step 408, the server device may determine the second user identifier is associated with the data associated with the user device and at least one unidentified device. The server device may determine the unidentified device and the user device are the same device. The server device may associate the unidentified device with the user device, and the server device may store the indication of the association between the unidentified device and the user device. Thus, the server device may be able to determine additional unidentified device data is associated with the second user identifier, and the server device may determine that additional unidentified devices associated with the additional unidentified device data are the same as the user device. The server device may use the second user identifier to uniquely identify the user device at any number of different networks.

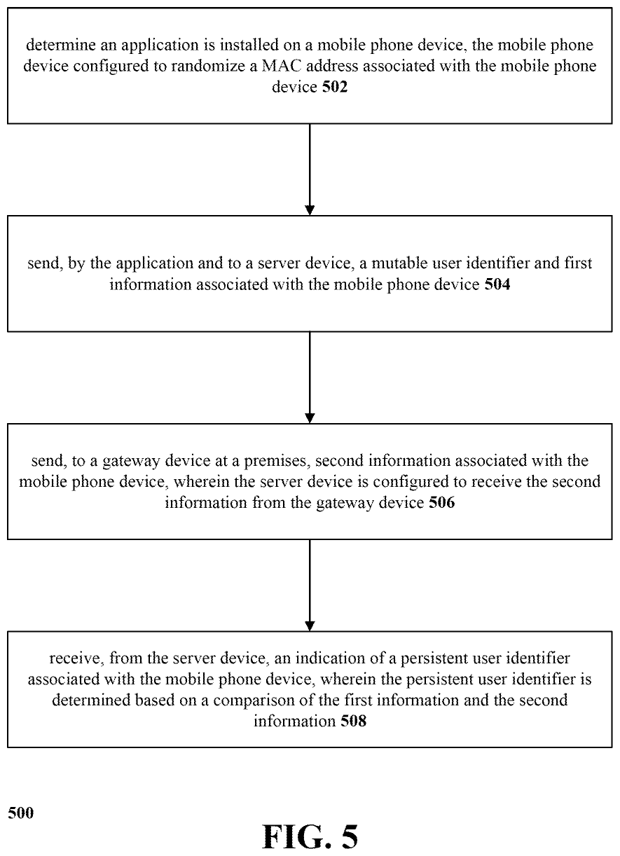

FIG. 5 shows an example method. The method described in FIG. 5 may be used by a system, for example by a communications service provider, to determine a unique identifier of a user device, of a plurality of user devices, that may uniquely identify the user device over a plurality of different networks. For example, the method of FIG. 5 may be implemented by the system described in FIG. 1. The method of FIG. 5 may be performed, for example, by one or more of the user device 104, the application 106, the server device 108, or the gateway device 118 of the system 100 of FIG. 1. For example, the method may take place, at least in part at a location associated with a network, such as a home network, or at a cloud server system.

At step 502, an application, for example application 106, may be installed on a mobile phone device, and the mobile phone device may be configured to randomize a MAC address associated with the mobile phone device. The mobile phone device may be any type of mobile phone device, such as a smart phone, a cellular phone, a PDA, a tablet, or the like. The application may be associated with the system described herein, such as the system described in FIG. 1. The mobile phone device may be configured with a mechanism to randomize a MAC address presented by the mobile phone device. Accordingly, traditional methods for uniquely identifying the mobile phone device may be ineffective due to a periodically changing MAC address.

At step 504, the application may send, to the server device, a first user identifier and first information associated with the mobile phone device. For example, the server device may be located external to a premises associated with a home network of the mobile phone device. The first identifier may be a particular unique identifier. The unique identifier may uniquely identify the particular mobile phone device. However, the unique identifier may not be universally applicable. For example, the unique identifier may periodically change, the unique identifier may change in response to a particular trigger condition, or the unique identifier may only be associated with a particular application, such as application 106. Therefore, the unique identifier may be useful to identify the mobile phone device in one or more circumstances but not all circumstances. The mobile phone device may send the first information associated with the mobile phone device. For example, the first information associated with the mobile phone device may comprise the IP address, the brand, the model, or the like, of the mobile phone device. The first information may comprise a characteristic, a setting, or a behavior of the mobile phone device.

At step 506, the application may send, to a gateway device located at the premises, second information associated with the mobile phone device, wherein the server device is configured to receive the second information from the gateway device. For example, the second information associated with the mobile phone device may comprise the IP address, the brand, the model, or the like, of the mobile phone device. The second information may comprise a characteristic, a setting, or a behavior of the mobile phone device. The second information may not comprise a unique identifier associated with the mobile phone device. Alternatively, the mobile phone device may not affirmatively send the second information to the gateway device, but the gateway device may determine the second information about the user device during an interaction between the mobile phone device and the gateway device. The gateway device may send the second information associated with the mobile phone device to the server device located external to the premises.

At step 508, the application may receive, from the server device, an indication of a second user identifier associated with the mobile phone device, wherein the second user identifier is determined based on a comparison of the first information and the second information. The second user identifier received from the server device may be a unique identifier associated with the mobile phone device. The second user identifier may be a unique identifier configured to determine the identity of the mobile phone device at any network, rather than just at a single network associated with the user identifier.

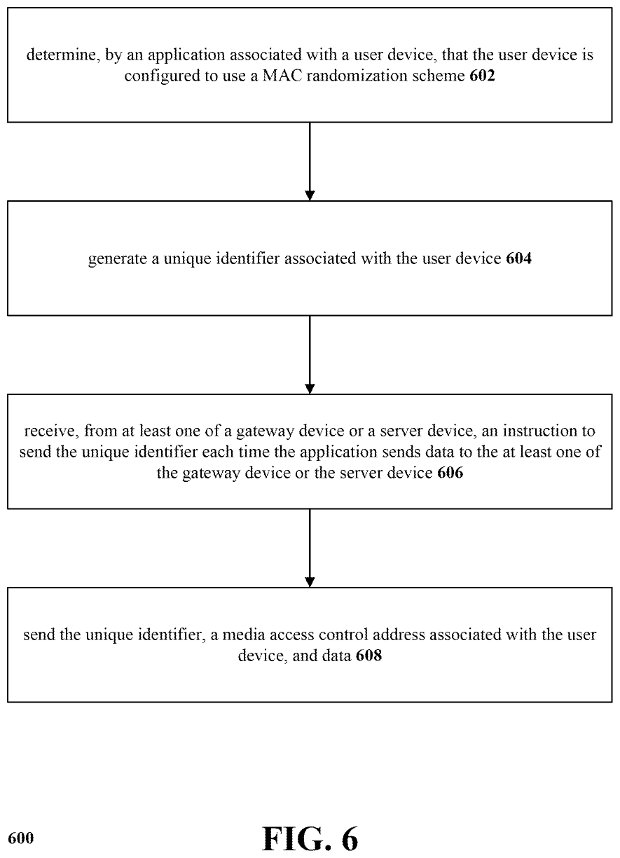

FIG. 6 shows an example method. The method described in FIG. 6 may be used by a system, for example by a communications service provider, to determine a unique identifier of a user device, of a plurality of user devices, that may uniquely identify the user device over a plurality of different networks. For example, the method of FIG. 6 may be implemented by the system described in FIG. 1. The method of FIG. 6 may be performed, for example, by one or more of the user device 104, the application 106, the server device 108, or the gateway device 118 of the system 100 of FIG. 1. For example, the method may take place, at least in part at a location associated with a network, such as a home network, or at a cloud server system.

At step 602, an application, for example application 106, may be installed on a user device, for example a mobile phone device, and the mobile phone device may be configured to randomize a MAC address associated with the mobile phone device. The application may determine that the user device is configured to use a MAC randomization scheme. The application may determine the user device is configured to generate random MAC addresses. The application may determine the user device is configured to generate the random MAC addresses based on a trigger condition, an elapsed time, or an action taken by at least one of the user device or any one or more of a plurality of applications associated with the user device.

Even though the application may be installed on the user device, the application may have limited access to information associated with the user device. For example, if the user device is a mobile phone, the application may not have access to phone calling capabilities, a list of contacts stored on the mobile phone, or any other particular information associated with the mobile phone. For example, the application may receive a MAC address from the mobile phone. The application may know the mobile phone or other user device employs the MAC randomization scheme. However, the application may not know the particular MAC randomization scheme employed by the user device. Additionally, or alternatively, a gateway device or a server device associated with the system, for example server device 108 or gateway device 118 may be configured to know that the user device employs a MAC randomization scheme. The server device, for example server device 108 and the gateway device 118 may not know the particular MAC randomization scheme employed by the user device. The application, the server device, and the gateway device may each determine the user device employs a MAC randomization scheme before, during, or after receiving communication information from the user device.

At step 604, the application, for example application 106, may generate a unique identifier associated with the user device. Additionally, or alternatively, either one of, or both of the server device 108 and the gateway device 118 may generate the unique identifier associated with the user device. Either one of, or both of the server device 108 and the gateway device 118 may instruct the application 106 to generate the unique identifier. Either one of, or both of the server device 108 or the gateway device 118 may generate the unique identifier and send an indication of the unique identifier to the application 106. Any one of, or multiple of the application 106, the server device 108, or the gateway device 118 may be configured to store an indication of the unique identifier.

Any one of, or multiple of the application 106, the server device 108, or the gateway device 118 may be configured with a protocol enabled to determine the unique identifier. For example, the unique identifier may comprise a string, text, numbers, characters, any combination of the above, or any unique identifier used to uniquely identify a device. However, the unique identifier may not be natively identifiable or decipherable to the server device 108, the gateway device 118, or any generic device or system. Instead, a device or system may require a protocol configured to determine the unique identifier. For example, the server device 108 and the gateway device 118 may be configured with the protocol. Based on configuring the server device 108 or the gateway device 118 with the protocol, the unique identifier may be detectable in a communication received from the application 106 or from any other device or system that sends the unique identifier. For example, the application 106 may be configured to send data, for example packets of data, to the gateway device 118 or the server device 108 based on a request for the data. The application 106 may send the data along with the unique identifier. The unique identifier may be appended to one portion of the data. The unique identifier may be layered on top of the data. The unique identifier may be embedded in the data. The unique identifier may be incorporated into a transmission associated with the data in any other suitable method. The protocol may allow the server device 108 or the gateway device 118 to determine the unique identifier. Therefore, the server device 108 and the gateway device 118 may be able to determine an identity of the user device based on the unique identifier.

At step 606, the application 106 may receive, from at least one of the server device 108 or the gateway device 118, an instruction to send the unique identifier each time the application 106 sends data to the server device 108 or the gateway device 118. For example, the application 106 may receive a request for data. The application may send to at least one of the server device 108 or the gateway device 118, the data associated with the request, and the application 106 may send the unique identifier along with the data. Additionally, the application 106 may send the MAC address along with the data and the unique identifier. However, the application 106 may know the MAC address is a randomized MAC address associated with the user device.

The server device 108 and the gateway device 118 may know the user device is configured to determine randomized MAC addresses. The server device 108 and the gateway device 118 may know that any MAC address received from the user device, or an application associated with the user device, may be a randomized MAC address. The server device 108 and the gateway device 118 may determine the unique identifier and use the unique identifier to determine an identity of the user device. The server device 108 and the gateway device 118 may be configured to disregard some or all of the MAC addresses received from the application 106 associated with the user device.

At step 608, the application 106 may send the unique identifier, the randomized MAC address, and data. The server device 108 and the gateway device 118 may receive a series of transmissions from the application 106 associated with the user device. Each of the transmissions may include a randomized MAC address associated with the user device. However, some or all of the transmissions may include different randomized MAC addresses. For example, the application 106 may send a first message to at least one of the server device 108 or the gateway device 118 with the unique identifier and a first randomized MAC address. The application 106 may send a second message to at least one of the server device 108 or the gateway device 118 with the unique identifier and a second randomized MAC address. The server device 108 and the gateway device 118 may be configured to determine the unique identifier in both messages matches a unique identifier associated with the user device, and the server device 108 and the gateway device 118 may disregard the first randomized MAC address and the second randomized MAC address. Even if the first randomized MAC address and the second randomized MAC address are the same, the server device 108 and the gateway device 118 may disregard the first and second randomized MAC addresses and determine the identity of the user device based on the unique identifier.

The server device 108 and the gateway device 118 may be configured to correlate or compile different messages associated with the same user device, even if some or all of the messages received from the application 106 are associated with a different randomized MAC address. For example, the server device 108 or the gateway device 118 may be configured to determine a quantity of cellular data used by a mobile phone. The server device 108 or the gateway device 118 may determine a total quantity of cellular data used by the mobile phone across each request made by the mobile phone. For example, the server device 108 or the gateway device 118 may be configured to alert a user associated with the user device that a data usage cap is almost exceeded or is already exceeded based on the total quantity of cellular data used by the mobile phone. For example, the mobile phone may be associated with a one GB data allowance for a one month period. The server device 108 or the gateway device 118 may determine a total quantity of cellular data used by the mobile phone is greater than one GB, and a user associated with the mobile phone may be alerted of the excessive data usage. For example, parental controls may be implemented based on the unique identifier determined at least one of the application 106, the server device 108, or the gateway device 118. For example, a parent may determine that a child is not allowed to access a video game for longer than a period of time. The child may not be allowed to play the video game for greater than one hour per day. However, in a conventional system, the child's mobile phone may update its randomized MAC address more often than once every hour, for example. However, because application 106, server device 108, and gateway device 118 may determine the identity of the mobile phone based on the unique identifier, without requiring the use of the randomized MAC address, the system may be able to accurately track how much time the child spends playing the video game. Accordingly, the system may properly record how long the child is playing the video game, and the system may prevent the child from accessing the video game for more than one hour each day.

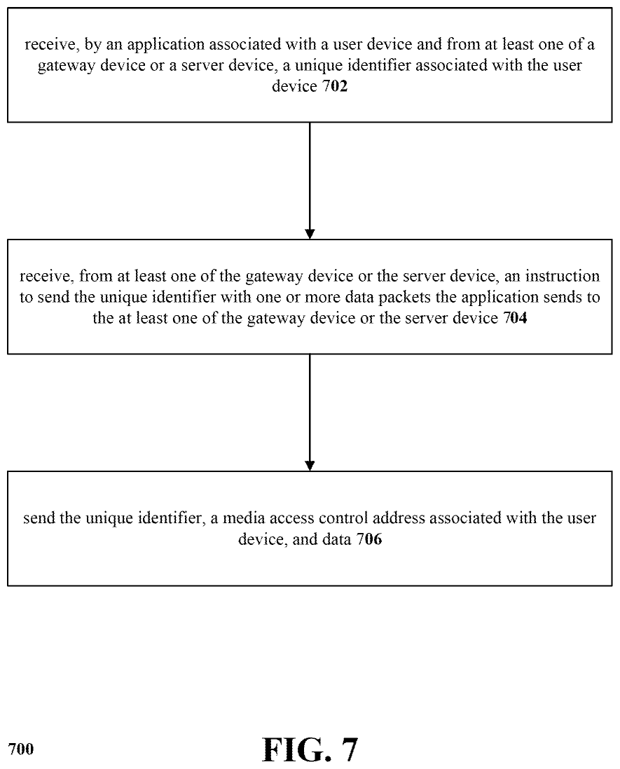

FIG. 7 shows an example method. The method described in FIG. 7 may be used by a system, for example by a communications service provider, to determine a unique identifier of a user device, of a plurality of user devices, that may uniquely identify the user device over a plurality of different networks. For example, the method of FIG. 7 may be implemented by the system described in FIG. 1. The method of FIG. 7 may be performed, for example, by one or more of the user device 104, the application 106, the server device 108, or the gateway device 118 of the system 100 of FIG. 1. For example, the method may take place, at least in part at a location associated with a network, such as a home network, or at a cloud server system.

At step 702, an application, for example application 106, may be installed on a user device, for example a mobile phone device, and the mobile phone device may be configured to randomize a MAC address associated with the mobile phone device.

Even though the application may be installed on the user device, the application may have limited access to information associated with the user device. For example, if the user device is a mobile phone, the application may not have access to phone calling capabilities, a list of contacts stored on the mobile phone, or any other particular information associated with the mobile phone. For example, the application may receive a MAC address from the mobile phone. A gateway device or a server device associated with the system, for example server device 108 or gateway device 118 may be configured to determine that the user device employs a MAC randomization scheme. The server device, for example server device 108 and the gateway device 118 may not know the particular MAC randomization scheme employed by the user device. The application, the server device, and the gateway device may each determine the user device employs a MAC randomization scheme before, during, or after receiving communication information from the user device. The server device 108 or the gateway device 118 may determine the user device is configured to generate the random MAC addresses based on a trigger condition, an elapsed time, or an action taken by at least one of the user device or any one or more of a plurality of applications associated with the user device.

At least one of the server device 108 or the gateway device 118 may generate a unique identifier associated with the user device. Either one of, or both of the server device 108 and the gateway device 118 may instruct the application 106 to generate the unique identifier. Either one of, or both of the server device 108 or the gateway device 118 may generate the unique identifier and send an indication of the unique identifier to the application 106. Any one of, or multiple of the application 106, the server device 108, or the gateway device 118 may be configured to store an indication of the unique identifier.

Any one of, or multiple of the application 106, the server device 108, or the gateway device 118 may be configured with a protocol enabled to determine the unique identifier. For example, the unique identifier may comprise a string, text, numbers, characters, any combination of the above, or any unique identifier used to uniquely identify a device. However, the unique identifier may not be natively identifiable or decipherable to the server device 108, the gateway device 118, or any generic device or system. Instead, a device or system may require a protocol configured to determine the unique identifier. For example, the server device 108 and the gateway device 118 may be configured with the protocol. Based on configuring the server device 108 or the gateway device 118 with the protocol, the unique identifier may be detectable in a communication received from the application 106 or from any other device or system that sends the unique identifier. For example, the application 106 may be configured to send data, for example packets of data, to the gateway device 118 or the server device 108 based on a request for the data. The application 106 may send the data along with the unique identifier. The unique identifier may be appended to one portion of the data. The unique identifier may be layered on top of the data. The unique identifier may be embedded in the data. The unique identifier may be incorporated into a transmission associated with the data in any other suitable method. The protocol may allow the server device 108 or the gateway device 118 to determine the unique identifier. Therefore, the server device 108 and the gateway device 118 may be able to determine an identity of the user device based on the unique identifier.

At step 704, the application 106 may receive, from at least one of the server device 108 or the gateway device 118, an instruction to send the unique identifier each time the application 106 sends data to the server device 108 or the gateway device 118. For example, the application 106 may receive a request for data. The application may send to at least one of the server device 108 or the gateway device 118, the data associated with the request, and the application 106 may send the unique identifier along with the data. Additionally, the application 106 may send the MAC address along with the data and the unique identifier. However, the application 106 may know the MAC address is a randomized MAC address associated with the user device.

The server device 108 and the gateway device 118 may know the user device is configured to determine randomized MAC addresses. The server device 108 and the gateway device 118 may know that any MAC address received from the user device, or an application associated with the user device, may be a randomized MAC address. The server device 108 and the gateway device 118 may determine the unique identifier and use the unique identifier to determine an identity of the user device. The server device 108 and the gateway device 118 may be configured to disregard some or all of the MAC addresses received from the application 104 associated with the user device.

At step 706, the application 106 may send the unique identifier, the randomized MAC address, and the data. The server device 108 and the gateway device 118 may receive a series of transmissions from the application 106 associated with the user device. Each of the transmissions may include a randomized MAC address associated with the user device. However, some or all of the transmissions may include different randomized MAC addresses. For example, the application 106 may send a first message to at least one of the server device 108 or the gateway device 118 with the unique identifier and a first randomized MAC address. The application 106 may send a second message to at least one of the server device 108 or the gateway device 118 with the unique identifier and a second randomized MAC address. The server device 108 and the gateway device 118 may be configured to determine the unique identifier in both messages matches a unique identifier associated with the user device, and the server device 108 and the gateway device 118 may disregard the first randomized MAC address and the second randomized MAC address. Even if the first randomized MAC address and the second randomized MAC address are the same, the server device 108 and the gateway device 118 may disregard the first and second randomized MAC addresses and determine the identity of the user device based on the unique identifier.

The server device 108 and the gateway device 118 may be configured to correlate or compile different messages associated with the same user device, even if some or all of the messages received from the application 106 are associated with a different randomized MAC address. For example, the server device 108 or the gateway device 118 may be configured to determine a quantity of cellular data used by a mobile phone. The server device 108 or the gateway device 118 may determine a total quantity of cellular data used by the mobile phone across each request made by the mobile phone. For example, the server device 108 or the gateway device 118 may be configured to alert a user associated with the user device that a data usage cap is almost exceeded or is already exceeded based on the total quantity of cellular data used by the mobile phone. For example, the mobile phone may be associated with a one GB data allowance for a one month period. The server device 108 or the gateway device 118 may determine a total quantity of cellular data used by the mobile phone is greater than one GB, and a user associated with the mobile phone may be alerted of the excessive data usage. For example, parental controls may be implemented based on the unique identifier determined at least one of the application 106, the server device 108, or the gateway device 118. For example, a parent may determine that a child is not allowed to access a video game for longer than a period of time. The child may not be allowed to play the video game for greater than one hour per day. However, in a conventional system, the child's mobile phone may update its randomized MAC address more often than once every hour, for example. However, because application 106, server device 108, and gateway device 118 may determine the identity of the mobile phone based on the unique identifier, without requiring the use of the randomized MAC address, the system may be able to accurately track how much time the child spends playing the video game. Accordingly, the system may properly record how long the child is playing the video game, and the system may prevent the child from accessing the video game for more than one hour each day.

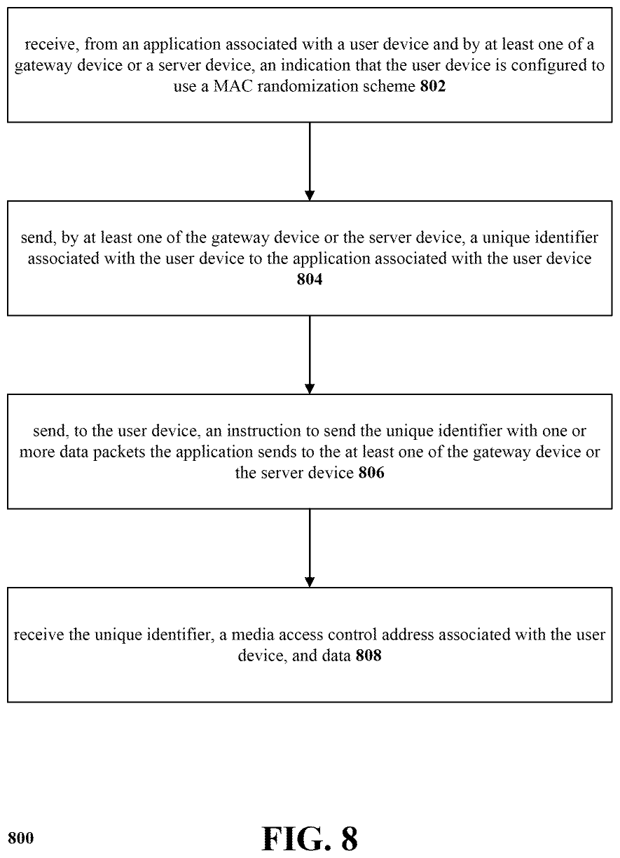

FIG. 8 shows an example method. The method described in FIG. 8 may be used by a system, for example by a communications service provider, to determine a unique identifier of a user device, of a plurality of user devices, that may uniquely identify the user device over a plurality of different networks. For example, the method of FIG. 8 may be implemented by the system described in FIG. 1. The method of FIG. 8 may be performed, for example, by one or more of the server device 108, or the gateway device 118 of the system 100 of FIG. 1. For example, the method may take place, at least in part at a location associated with a network, such as a home network, or at a cloud server system.

At step 802, an application 106 may determine a user device is configured to randomize a MAC address associated with the user device. The application 106 may be configured to communicate with the server device 108 or the gateway device 118, and the application 106 may send an indication that the user device is configured to use a MAC randomization scheme to at least one of the server device 108 or the gateway device 118.

Even though the application may be installed on the user device, the application may have limited access to information associated with the user device. For example, if the user device is a mobile phone, the application may not have access to phone calling capabilities, a list of contacts stored on the mobile phone, or any other particular information associated with the mobile phone. For example, the application may receive a MAC address from the mobile phone. The application 106 may be configured to determine that the user device employs a MAC randomization scheme. The application 106 may not know the particular MAC randomization scheme employed by the user device. The application, the server device, and the gateway device may each determine the user device employs a MAC randomization scheme before, during, or after receiving communication information from the user device. The application 106 may determine the user device is configured to generate the random MAC addresses based on a trigger condition, an elapsed time, or an action taken by at least one of the user device or any one or more of a plurality of applications associated with the user device.

At least one of the server device 108 or the gateway device 118 may generate a unique identifier associated with the user device. Either one of, or both of the server device 108 and the gateway device 118 may instruct the application 106 to generate the unique identifier. Either one of, or both of the server device 108 or the gateway device 118 may generate the unique identifier and send an indication of the unique identifier to the application 106. Any one of, or multiple of the application 106, the server device 108, or the gateway device 118 may be configured to store an indication of the unique identifier.

Any one of, or multiple of the application 106, the server device 108, or the gateway device 118 may be configured with a protocol enabled to determine the unique identifier. For example, the unique identifier may comprise a string, text, numbers, characters, any combination of the above, or any unique identifier used to uniquely identify a device. However, the unique identifier may not be natively identifiable or decipherable to the server device 108, the gateway device 118, or any generic device or system. Instead, a device or system may require a protocol configured to determine the unique identifier. For example, the server device 108 and the gateway device 118 may be configured with the protocol. Based on configuring the server device 108 or the gateway device 118 with the protocol, the unique identifier may be detectable in a communication received from the application 106 or from any other device or system that sends the unique identifier. For example, the application 106 may be configured to send data, for example packets of data, to the gateway device 118 or the server device 108 based on a request for the data. The application 106 may send the data along with the unique identifier. The unique identifier may be appended to one portion of the data. The unique identifier may be layered on top of the data. The unique identifier may be embedded in the data. The unique identifier may be incorporated into a transmission associated with the data in any other suitable method. The protocol may allow the server device 108 or the gateway device 118 to determine the unique identifier. Therefore, the server device 108 and the gateway device 118 may be able to determine an identity of the user device based on the unique identifier.

At step 804, at least one of the server device 108 or the gateway device 118, may generate a unique identifier associated with the user device. Additionally, or alternatively, application 106 may generate the unique identifier associated with the user device. Either one of, or both of the server device 108 and the gateway device 118 may instruct the application 106 to generate the unique identifier. Either one of, or both of the server device 108 or the gateway device 118 may generate the unique identifier and send an indication of the unique identifier to the application 106. Any one of, or multiple of the application 106, the server device 108, or the gateway device 118 may be configured to store an indication of the unique identifier.

Any one of, or multiple of the application 106, the server device 108, or the gateway device 118 may be configured with a protocol enabled to determine the unique identifier. For example, the unique identifier may comprise a string, text, numbers, characters, any combination of the above, or any unique identifier used to uniquely identify a device. However, the unique identifier may not be natively identifiable or decipherable to the server device 108, the gateway device 118, or any generic device or system. Instead, a device or system may require a protocol configured to determine the unique identifier. For example, the server device 108 and the gateway device 118 may be configured with the protocol. Based on configuring the server device 108 or the gateway device 118 with the protocol, the unique identifier may be detectable in a communication received from the application 106 or from any other device or system that sends the unique identifier. For example, the application 106 may be configured to send data, for example packets of data, to the gateway device 118 or the server device 108 based on a request for the data. The application 106 may send the data along with the unique identifier. The unique identifier may be appended to one portion of the data. The unique identifier may be layered on top of the data. The unique identifier may be embedded in the data. The unique identifier may be incorporated into a transmission associated with the data in any other suitable method. The protocol may allow the server device 108 or the gateway device 118 to determine the unique identifier. Therefore, the server device 108 and the gateway device 118 may be able to determine an identity of the user device based on the unique identifier.

At step 806, at least one of the server device 108 or the gateway device 118 may send, to the application 106, an instruction to send the unique identifier each time the application 106 sends data to the server device 108 or the gateway device 118. For example, the application 106 may receive a request for data. The application may send to at least one of the server device 108 or the gateway device 118, the data associated with the request, and the application 106 may send the unique identifier along with the data. Additionally, the application 106 may send the MAC address along with the data and the unique identifier. However, the application 106 may know the MAC address is a randomized MAC address associated with the user device.

The server device 108 and the gateway device 118 may know the user device is configured to determine randomized MAC addresses. The server device 108 and the gateway device 118 may know that any MAC address received from the user device, or an application associated with the user device, may be a randomized MAC address. The server device 108 and the gateway device 118 may determine the unique identifier and use the unique identifier to determine an identity of the user device. The server device 108 and the gateway device 118 may be configured to disregard some or all of the MAC addresses received from the application 106 associated with the user device.

At step 808, at least one of the server device 108 or the gateway device 118 may receive the unique identifier, the randomized MAC address, and the data from the application 106. The server device 108 and the gateway device 118 may receive a series of transmissions from the application 106 associated with the user device. Each of the transmissions may include a randomized MAC address associated with the user device. However, some or all of the transmissions may include different randomized MAC addresses. For example, the application 106 may send a first message to at least one of the server device 108 or the gateway device 118 with the unique identifier and a first randomized MAC address. The application 106 may send a second message to at least one of the server device 108 or the gateway device 118 with the unique identifier and a second randomized MAC address. The server device 108 and the gateway device 118 may be configured to determine the unique identifier in both messages matches a unique identifier associated with the user device, and the server device 108 and the gateway device 118 may disregard the first randomized MAC address and the second randomized MAC address. Even if the first randomized MAC address and the second randomized MAC address are the same, the server device 108 and the gateway device 118 may disregard the first and second randomized MAC addresses and determine the identity of the user device based on the unique identifier.

The server device 108 and the gateway device 118 may be configured to correlate or compile different messages associated with the same user device, even if some or all of the messages received from the application 106 are associated with a different randomized MAC address. For example, the server device 108 or the gateway device 118 may be configured to determine a quantity of cellular data used by a mobile phone. The server device 108 or the gateway device 118 may determine a total quantity of cellular data used by the mobile phone across each request made by the mobile phone. For example, the server device 108 or the gateway device 118 may be configured to alert a user associated with the user device that a data usage cap is almost exceeded or is already exceeded based on the total quantity of cellular data used by the mobile phone. For example, the mobile phone may be associated with a one GB data allowance for a one month period. The server device 108 or the gateway device 118 may determine a total quantity of cellular data used by the mobile phone is greater than one GB, and a user associated with the mobile phone may be alerted of the excessive data usage. For example, parental controls may be implemented based on the unique identifier determined at least one of the application 106, the server device 108, or the gateway device 118. For example, a parent may determine that a child is not allowed to access a video game for longer than a period of time. The child may not be allowed to play the video game for greater than one hour per day. However, in a conventional system, the child's mobile phone may update its randomized MAC address more often than once every hour, for example. However, because application 106, server device 108, and gateway device 118 may determine the identity of the mobile phone based on the unique identifier, without requiring the use of the randomized MAC address, the system may be able to accurately track how much time the child spends playing the video game. Accordingly, the system may properly record how long the child is playing the video game, and the system may prevent the child from accessing the video game for more than one hour each day.

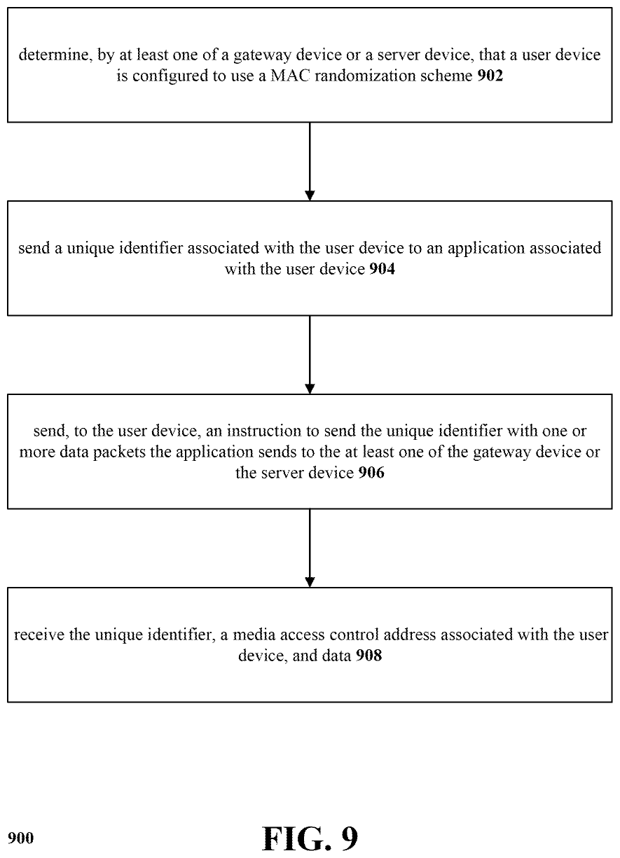

FIG. 9 shows an example method. The method described in FIG. 9 may be used by a system, for example by a communications service provider, to determine a unique identifier of a user device, of a plurality of user devices, that may uniquely identify the user device over a plurality of different networks. For example, the method of FIG. 9 may be implemented by the system described in FIG. 1. The method of FIG. 9 may be performed, for example, by one or more of the server device 108, or the gateway device 118 of the system 100 of FIG. 1. For example, the method may take place, at least in part at a location associated with a network, such as a home network, or at a cloud server system.

At step 902, at least one of the server device 108 or the gateway device 118 may determine a user device is configured to randomize a MAC address associated with the user device. The server device 108 or the gateway device 118 may be configured to communicate with an application 106 installed on the user device.

Even though the application may be installed on the user device, the application may have limited access to information associated with the user device. For example, if the user device is a mobile phone, the application may not have access to phone calling capabilities, a list of contacts stored on the mobile phone, or any other particular information associated with the mobile phone. For example, the application may receive a MAC address from the mobile phone. At least one of the server device 108 or the gateway device 118 may be configured to determine that the user device employs a MAC randomization scheme. The server device 108 and the gateway device 118 may not know the particular MAC randomization scheme employed by the user device. The server device 108 and the gateway device 118 may each determine the user device employs a MAC randomization scheme before, during, or after receiving communication information from the user device. At least one of the server device 108 or the gateway device 118 may determine the user device is configured to generate the random MAC addresses based on a trigger condition, an elapsed time, or an action taken by at least one of the user device or any one or more of a plurality of applications associated with the user device.

At least one of the server device 108 or the gateway device 118 may generate a unique identifier associated with the user device. Either one of, or both of the server device 108 and the gateway device 118 may instruct the application 106 to generate the unique identifier. Either one of, or both of the server device 108 or the gateway device 118 may generate the unique identifier and send an indication of the unique identifier to the application 106. Any one of, or multiple of the application 106, the server device 108, or the gateway device 118 may be configured to store an indication of the unique identifier.

Any one of, or multiple of the application 106, the server device 108, or the gateway device 118 may be configured with a protocol enabled to determine the unique identifier. For example, the unique identifier may comprise a string, text, numbers, characters, any combination of the above, or any unique identifier used to uniquely identify a device. However, the unique identifier may not be natively identifiable or decipherable to the server device 108, the gateway device 118, or any generic device or system. Instead, a device or system may require a protocol configured to determine the unique identifier. For example, the server device 108 and the gateway device 118 may be configured with the protocol. Based on configuring the server device 108 or the gateway device 118 with the protocol, the unique identifier may be detectable in a communication received from the application 106 or from any other device or system that sends the unique identifier. For example, the application 106 may be configured to send data, for example packets of data, to the gateway device 118 or the server device 108 based on a request for the data. The application 106 may send the data along with the unique identifier. The unique identifier may be appended to one portion of the data. The unique identifier may be layered on top of the data. The unique identifier may be embedded in the data. The unique identifier may be incorporated into a transmission associated with the data in any other suitable method. The protocol may allow the server device 108 or the gateway device 118 to determine the unique identifier. Therefore, the server device 108 and the gateway device 118 may be able to determine an identity of the user device based on the unique identifier.

At step 904, at least one of the server device 108 or the gateway device 118 may generate a unique identifier associated with the user device. Additionally, or alternatively, application 106 may generate the unique identifier associated with the user device. Either one of, or both of the server device 108 and the gateway device 118 may instruct the application 106 to generate the unique identifier. Either one of, or both of the server device 108 or the gateway device 118 may generate the unique identifier and send an indication of the unique identifier to the application 106. Any one of, or multiple of the application 106, the server device 108, or the gateway device 118 may be configured to store an indication of the unique identifier.

Any one of, or multiple of the application 106, the server device 108, or the gateway device 118 may be configured with a protocol enabled to determine the unique identifier. For example, the unique identifier may comprise a string, text, numbers, characters, any combination of the above, or any unique identifier used to uniquely identify a device. However, the unique identifier may not be natively identifiable or decipherable to the server device 108, the gateway device 118, or any generic device or system. Instead, a device or system may require a protocol configured to determine the unique identifier. For example, the server device 108 and the gateway device 118 may be configured with the protocol. Based on configuring the server device 108 or the gateway device 118 with the protocol, the unique identifier may be detectable in a communication received from the application 106 or from any other device or system that sends the unique identifier. For example, the application 106 may be configured to send data, for example packets of data, to the gateway device 118 or the server device 108 based on a request for the data. The application 106 may send the data along with the unique identifier. The unique identifier may be appended to one portion of the data. The unique identifier may be layered on top of the data. The unique identifier may be embedded in the data. The unique identifier may be incorporated into a transmission associated with the data in any other suitable method. The protocol may allow the server device 108 or the gateway device 118 to determine the unique identifier. Therefore, the server device 108 and the gateway device 118 may be able to determine an identity of the user device based on the unique identifier.

At step 906, at least one of the server device 108 or the gateway device 118 may send, to the application 106, an instruction to send the unique identifier each time the application 106 sends data to the server device 108 or the gateway device 118. For example, the application 106 may receive a request for data. The application may send to at least one of the server device 108 or the gateway device 118, the data associated with the request, and the application 106 may send the unique identifier along with the data. Additionally, the application 106 may send the MAC address along with the data and the unique identifier. However, the application 106 may know the MAC address is a randomized MAC address associated with the user device.

The server device 108 and the gateway device 118 may know the user device is configured to determine randomized MAC addresses. The server device 108 and the gateway device 118 may know that any MAC address received from the user device, or an application associated with the user device, may be a randomized MAC address. The server device 108 and the gateway device 118 may determine the unique identifier and use the unique identifier to determine an identity of the user device. The server device 108 and the gateway device 118 may be configured to disregard some or all of the MAC addresses received from the application 106 associated with the user device.

At step 908, at least one of the server device 108 or the gateway device 118 may receive the unique identifier, the randomized MAC address, and the data from the application 106. The server device 108 and the gateway device 118 may receive a series of transmissions from the application 106 associated with the user device. Each of the transmissions may include a randomized MAC address associated with the user device. However, some or all of the transmissions may include different randomized MAC addresses. For example, the application 106 may send a first message to at least one of the server device 108 or the gateway device 118 with the unique identifier and a first randomized MAC address. The application 106 may send a second message to at least one of the server device 108 or the gateway device 118 with the unique identifier and a second randomized MAC address. The server device 108 and the gateway device 118 may be configured to determine the unique identifier in both messages matches a unique identifier associated with the user device, and the server device 108 and the gateway device 118 may disregard the first randomized MAC address and the second randomized MAC address. Even if the first randomized MAC address and the second randomized MAC address are the same, the server device 108 and the gateway device 118 may disregard the first and second randomized MAC addresses and determine the identity of the user device based on the unique identifier.

The server device 108 and the gateway device 118 may be configured to correlate or compile different messages associated with the same user device, even if some or all of the messages received from the application 106 are associated with a different randomized MAC address. For example, the server device 108 or the gateway device 118 may be configured to determine a quantity of cellular data used by a mobile phone. The server device 108 or the gateway device 118 may determine a total quantity of cellular data used by the mobile phone across each request made by the mobile phone. For example, the server device 108 or the gateway device 118 may be configured to alert a user associated with the user device that a data usage cap is almost exceeded or is already exceeded based on the total quantity of cellular data used by the mobile phone. For example, the mobile phone may be associated with a one GB data allowance for a one month period. The server device 108 or the gateway device 118 may determine a total quantity of cellular data used by the mobile phone is greater than one GB, and a user associated with the mobile phone may be alerted of the excessive data usage. For example, parental controls may be implemented based on the unique identifier determined at least one of the application 106, the server device 108, or the gateway device 118. For example, a parent may determine that a child is not allowed to access a video game for longer than a period of time. The child may not be allowed to play the video game for greater than one hour per day. However, in a conventional system, the child's mobile phone may update its randomized MAC address more often than once every hour, for example. However, because application 106, server device 108, and gateway device 118 may determine the identity of the mobile phone based on the unique identifier, without requiring the use of the randomized MAC address, the system may be able to accurately track how much time the child spends playing the video game. Accordingly, the system may properly record how long the child is playing the video game, and the system may prevent the child from accessing the video game for more than one hour each day.

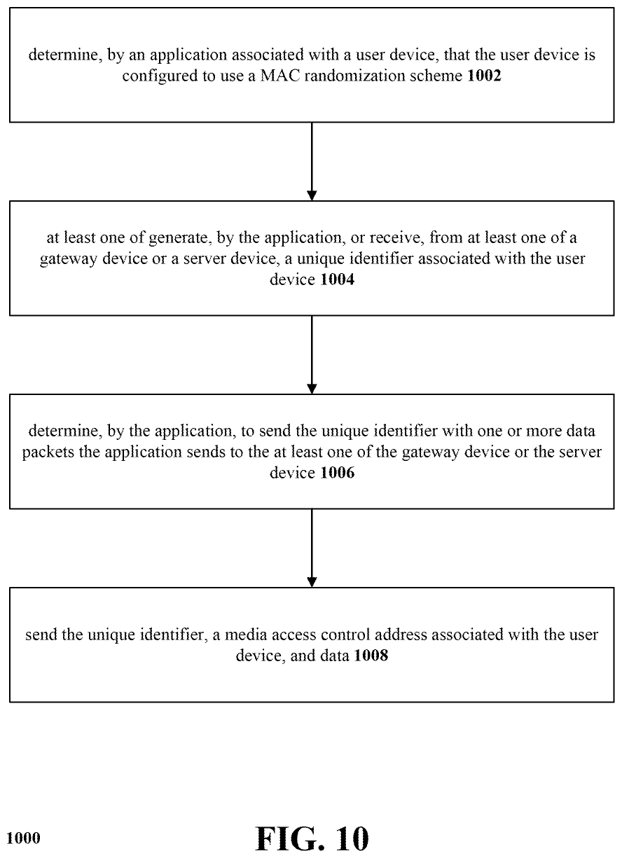

FIG. 10 shows an example method. The method described in FIG. 10 may be used by a system, for example by a communications service provider, to determine a unique identifier of a user device, of a plurality of user devices, that may uniquely identify the user device over a plurality of different networks. For example, the method of FIG. 10 may be implemented by the system described in FIG. 1. The method of FIG. 10 may be performed, for example, by one or more of the user device 104, the application 106, the server device 108, or the gateway device 118 of the system 100 of FIG. 1. For example, the method may take place, at least in part at a location associated with a network, such as a home network, or at a cloud server system.

At step 1002, an application, for example application 106, may be installed on a user device, for example a mobile phone device, and the mobile phone device may be configured to randomize a MAC address associated with the mobile phone device. The application may determine that the user device is configured to use a MAC randomization scheme. The application may determine the user device is configured to generate random MAC addresses. The application may determine the user device is configured to generate the random MAC addresses based on at least one of a trigger condition, an elapsed time, or an action taken by at least one of the user device or any one or more of a plurality of applications associated with the user device.

Even though the application may be installed on the user device, the application may have limited access to information associated with the user device. For example, if the user device is a mobile phone, the application may not have access to phone calling capabilities, a list of contacts stored on the mobile phone, or any other particular information associated with the mobile phone. For example, the application may receive a MAC address from the mobile phone. The application may know the mobile phone or other user device employs the MAC randomization scheme. However, the application may not know the particular MAC randomization scheme employed by the user device. Additionally, or alternatively, a gateway device or a server device associated with the system, for example server device 108 or gateway device 118 may be configured to know that the user device employs a MAC randomization scheme. The server device, for example server device 108 and the gateway device 118 may not know the particular MAC randomization scheme employed by the user device. The application, the server device, and the gateway device may each determine the user device employs a MAC randomization scheme before, during, or after receiving communication information from the user device.

At step 1004, the application, for example application 106, may generate a unique identifier associated with the user device. Additionally, or alternatively, either one of, or both of the server device 108 and the gateway device 118 may generate the unique identifier associated with the user device and the application may receive the unique identifier from at least one of the gateway device or the server device. Either one of, or both of the server device 108 or the gateway device 118 may generate the unique identifier and send an indication of the unique identifier to the application 106. Any one of, or multiple of the application 106, the server device 108, or the gateway device 118 may be configured to store an indication of the unique identifier.

Any one of, or multiple of the application 106, the server device 108, or the gateway device 118 may be configured with a protocol enabled to determine the unique identifier. For example, the unique identifier may comprise a string, text, numbers, characters, any combination of the above, or any unique identifier used to uniquely identify a device. However, the unique identifier may not be natively identifiable or decipherable to the server device 108, the gateway device 118, or any generic device or system. Instead, a device or system may require a protocol configured to determine the unique identifier. For example, the server device 108 and the gateway device 118 may be configured with the protocol. Based on configuring the server device 108 or the gateway device 118 with the protocol, the unique identifier may be detectable in a communication, for example in one or more data packets, received from the application 106 or from any other device or system that sends the unique identifier. For example, the application 106 may be configured to send data, for example packets of data, to the gateway device 118 or the server device 108. The application 106 may be further configured to send the data along with the unique identifier. The unique identifier may be appended to one portion of the data. The unique identifier may be layered on top of the data. The unique identifier may be embedded in the data. The unique identifier may be incorporated into a transmission associated with the data in any other suitable method. The protocol may allow the server device 108 or the gateway device 118 to determine the unique identifier. Therefore, the server device 108 and the gateway device 118 may be able to determine an identity of the user device based on the unique identifier.

At step 606, the application 106 may determine to send the unique identifier with at least one data packet the application 106 sends to the server device 108 or the gateway device 118. For example, the application 106 may receive a request for data. The application may send to at least one of the server device 108 or the gateway device 118, the data associated with the request, and the application 106 may send the unique identifier along with the data. Additionally, the application 106 may send the MAC address along with the data and the unique identifier. However, the application 106 may know the MAC address is a randomized MAC address associated with the user device.

The server device 108 and the gateway device 118 may know the user device is configured to determine randomized MAC addresses. The server device 108 and the gateway device 118 may know that any MAC address received from the user device, or an application associated with the user device, may be a randomized MAC address. The server device 108 and the gateway device 118 may determine the application 106 is configured to send the unique identifier with at least one data packet the application sends to the server device 108 or the gateway device 118. The server device 108 and the gateway device 118 may determine the unique identifier and use the unique identifier to determine an identity of the user device. The server device 108 and the gateway device 118 may be configured to disregard some or all of the MAC addresses received from the application 106 associated with the user device.

At step 608, the application 106 may send the unique identifier, the randomized MAC address, and data. The server device 108 and the gateway device 118 may receive a series of transmissions from the application 106 associated with the user device. Each of the transmissions may comprise a randomized MAC address associated with the user device. However, some or all of the transmissions may include different randomized MAC addresses. For example, the application 106 may send a first message to at least one of the server device 108 or the gateway device 118 with the unique identifier and a first randomized MAC address. The application 106 may send a second message to at least one of the server device 108 or the gateway device 118 with the unique identifier and a second randomized MAC address. The server device 108 and the gateway device 118 may be configured to determine the unique identifier in both messages matches a unique identifier associated with the user device, and the server device 108 and the gateway device 118 may disregard the first randomized MAC address and the second randomized MAC address. Even if the first randomized MAC address and the second randomized MAC address are the same, the server device 108 and the gateway device 118 may disregard the first and second randomized MAC addresses and determine the identity of the user device based on the unique identifier.

The server device 108 and the gateway device 118 may be configured to correlate or compile different messages associated with the same user device, even if some or all of the messages received from the application 106 are associated with a different randomized MAC address. For example, the server device 108 or the gateway device 118 may be configured to determine a quantity of cellular data used by a mobile phone. The server device 108 or the gateway device 118 may determine a total quantity of cellular data used by the mobile phone across each request made by the mobile phone. For example, the server device 108 or the gateway device 118 may be configured to alert a user associated with the user device that a data usage cap is almost exceeded or is already exceeded based on the total quantity of cellular data used by the mobile phone. For example, the mobile phone may be associated with a one GB data allowance for a one month period. The server device 108 or the gateway device 118 may determine a total quantity of cellular data used by the mobile phone is greater than one GB, and a user associated with the mobile phone may be alerted of the excessive data usage. For example, parental controls may be implemented based on the unique identifier determined at least one of the application 106, the server device 108, or the gateway device 118. For example, a parent may determine that a child is not allowed to access a video game for longer than a period of time. The child may not be allowed to play the video game for greater than one hour per day. However, in a conventional system, the child's mobile phone may update its randomized MAC address more often than once every hour, for example. However, because application 106, server device 108, and gateway device 118 may determine the identity of the mobile phone based on the unique identifier, without requiring the use of the randomized MAC address, the system may be able to accurately track how much time the child spends playing the video game. Accordingly, the system may properly record how long the child is playing the video game, and the system may prevent the child from accessing the video game for more than one hour each day.

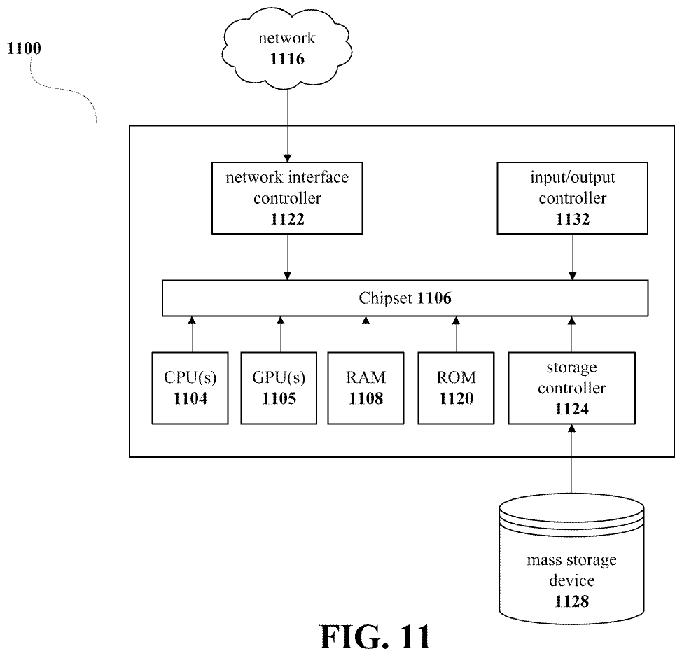

FIG. 11 shows an example computing device 1100. The example computing device 1100 may be used to implement any of the various devices or entities shown in FIG. 1 or FIG. 2, including, for example, the user device 104, the server device 108, the gateway device 118, or a database associated with the system. That is, the computing device 1100 shown in FIG. 11 may comprise any smartphone, server computer, workstation, access point, router, gateway, tablet computer, laptop computer, notebook computer, desktop computer, personal computer, network appliance, PDA, e-reader, user equipment (UE), mobile station, fixed or mobile subscriber unit, pager, wireless sensor, consumer electronics, or other computing device, and may be utilized to execute any aspects of the methods and apparatus described herein, such as to implement any of the apparatus of FIG. 1 or any of the methods described in relation to FIGS. 2-10.

The computing device 1100 may comprise a baseboard, or “motherboard,” which is a printed circuit board to which a multitude of components or devices may be connected by way of a system bus or other electrical communication paths. One or more central processing units (CPUs or “processors”) 1104 may operate in conjunction with a chipset 1106. The CPU(s) 1104 may be standard programmable processors that perform arithmetic and logical operations necessary for the operation of the computing device 1100.

The CPU(s) 1104 may perform the necessary operations by transitioning from one discrete physical state to the next through the manipulation of switching elements that differentiate between and change these states. Switching elements may generally comprise electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, or the like.

The CPU(s) 1104 may be augmented with or replaced by other processing units, such as GPU(s) 1105. The GPU(s) 1105 may comprise processing units specialized for but not necessarily limited to highly parallel computations, such as graphics and other visualization-related processing.

A chipset 1106 may provide an interface between the CPU(s) 1104 and the remainder of the components and devices on the baseboard. The chipset 1106 may provide an interface to a random-access memory (RAM) 1108 used as the main memory in the computing device 1100. The chipset 1106 may provide an interface to a computer-readable storage medium, such as a read-only memory (ROM) 1120 or non-volatile RAM (NVRAM) (not shown), for storing basic routines that may help to start up the computing device 1100 and to transfer information between the various components and devices. ROM 1120 or NVRAM may also store other software components necessary for the operation of the computing device 1100 in accordance with the aspects described herein.

The computing device 1100 may operate in a networked environment using logical connections to remote computing nodes and computer systems of the system 100. The chipset 1106 may comprise functionality for providing network connectivity through a network interface controller (NIC) 1122. A NIC 1122 may be capable of connecting the computing device 1100 to other computing nodes over the system 100. It should be appreciated that multiple NICs 1122 may be present in the computing device 1100, connecting the computing device to other types of networks and remote computer systems. The NIC 1122 may be configured to implement a wired local area network technology, such as IEEE 802.3 (“Ethernet”) or the like. The NIC 1122 may also comprise any suitable wireless network interface controller capable of wirelessly connecting and communicating with other devices or computing nodes on the system 100. For example, the NIC 1122 may operate in accordance with any of a variety of wireless communication protocols, including for example, the IEEE 802.11 (“Wi-Fi”) protocol, the IEEE 802.16 or 802.20 (“WiMAX”) protocols, the IEEE 802.15.4a (“Zigbee”) protocol, the 802.15.3c (“UWB”) protocol, or the like.

The computing device 1100 may be connected to a mass storage device 1128 that provides non-volatile storage (i.e., memory) for the computer. The mass storage device 1128 may store system programs, application programs, other program modules, and data, which have been described in greater detail herein. The mass storage device 1128 may be connected to the computing device 1100 through a storage controller 1124 connected to the chipset 1106. The mass storage device 1128 may consist of one or more physical storage units. A storage controller 1124 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 1100 may store data on a mass storage device 1128 by transforming the physical state of the physical storage units to reflect the information being stored. The specific transformation of a physical state may depend on various factors and on different implementations of this description. Examples of such factors may comprise, but are not limited to, the technology used to implement the physical storage units and whether the mass storage device 1128 is characterized as primary or secondary storage or the like.

For example, the computing device 1100 may store information to the mass storage device 1128 by issuing instructions through a storage controller 1124 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 1100 may read information from the mass storage device 1128 by detecting the physical states or characteristics of one or more particular locations within the physical storage units.

In addition to the mass storage device 1128 described herein, the computing device 1100 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 1100.

By way of example and not limitation, computer-readable storage media may comprise volatile and non-volatile, non-transitory computer-readable storage media, and removable and non-removable media implemented in any method or technology. However, as used herein, the term computer-readable storage media does not encompass transitory computer-readable storage media, such as signals. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other non-transitory medium that may be used to store the desired information in a non-transitory fashion.

A mass storage device, such as the mass storage device 1128 depicted in FIG. 10, may store an operating system utilized to control the operation of the computing device 1100. The operating system may comprise a version of the LINUX operating system. The operating system may comprise a version of the WINDOWS SERVER operating system from the MICROSOFT Corporation. According to additional aspects, the operating system may comprise a version of the UNIX operating system. Various mobile phone operating systems, such as IOS and ANDROID, may also be utilized. It should be appreciated that other operating systems may also be utilized. The mass storage device 1128 may store other system or application programs and data utilized by the computing device 1100.

The mass storage device 1128 or other computer-readable storage media may also be encoded with computer-executable instructions, which, when loaded into the computing device 1100, transforms the computing device from a general-purpose computing system into a special-purpose computer capable of implementing the aspects described herein. These computer-executable instructions transform the computing device 1100 by specifying how the CPU(s) 1104 transition between states, as described herein. The computing device 1100 may have access to computer-readable storage media storing computer-executable instructions, which, when executed by the computing device 1100, may perform the methods described in relation to FIGS. 3-10.

A computing device, such as the computing device 1100 depicted in FIG. 11, may also comprise an input/output controller 1132 for receiving and processing input from a number of input devices, such as a keyboard, a mouse, a touchpad, a touch screen, an electronic stylus, or other type of input device. Similarly, an input/output controller 1132 may provide output to a display, such as a computer monitor, a flat-panel display, a digital projector, a printer, a plotter, or other type of output device. It will be appreciated that the computing device 1100 may not comprise all of the components shown in FIG. 11, may comprise other components that are not explicitly shown in FIG. 11, or may utilize an architecture completely different than that shown in FIG. 11.

As described herein, a computing device may be a physical computing device, such as the computing device 1100 of FIG. 11. A computing device may also comprise a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems described herein are not limited to specific methods, specific components, or to particular implementations. It is also to be understood that the terminology used herein is not intended to be limiting.

As used in the specification and the appended claims, the singular forms “a,” “an,” and “the” comprise plural referents unless the context clearly dictates otherwise. Ranges may be expressed herein as from “about” one particular value, and/or to “about” another particular value. When such a range is expressed, another example may comprise from the one particular value and/or to the other particular value. It will be further understood that the endpoints of each of the ranges are significant both in relation to the other endpoint, and independently of the other endpoint.

“Optional” or “optionally” means that the subsequently described event or circumstance may or may not occur, and that the description comprises instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers, or steps. “Exemplary” means “an example of.”. “Such as” is not used in a restrictive sense, but for explanatory purposes.

Components and devices are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any combination of the described methods.

As will be appreciated by one skilled in the art, the methods and systems may take the form of entirely hardware, entirely software, or a combination of software and hardware aspects. Furthermore, the methods and systems may take the form of a computer program product on a computer-readable storage medium having computer-readable instructions (e.g., computer software or program code) embodied in the storage medium. More particularly, the present methods and systems may take the form of web-implemented computer software. Any suitable computer-readable storage medium may be utilized including hard disks, CD-ROMs, optical storage devices, or magnetic storage devices.

The methods and systems are described above with reference to block diagrams and flowcharts of methods, systems, apparatuses, and computer program products. It will be understood that each block of the block diagrams and flowcharts, and combinations of blocks in the block diagrams and flowcharts, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described herein may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added or removed. The example systems and components described herein may be configured differently than described. For example, elements may be added to, removed from, or rearranged.

It will also be appreciated that various items are shown as being stored in memory or on storage while being used, and that these items or portions thereof may be transferred between memory and other storage devices for purposes of memory management and data integrity. Alternatively, some or all of the software modules and/or systems may execute in memory on another device and communicate with the shown computing systems via inter-computer communication. Furthermore, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms. Accordingly, the present invention may be practiced with other computer system configurations.

While the methods and systems have been described in connection with specific examples, it is not intended that the scope be limited to the specific examples set forth.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including matters of logic with respect to arrangement of steps or operational flow and the plain meaning derived from grammatical organization or punctuation.

It will be apparent to those skilled in the art that various modifications and variations may be made without departing from the scope or spirit of the present disclosure. Alternatives will be apparent to those skilled in the art from consideration of the specification and practices described herein. It is intended that the specification and example figures be considered as exemplary only, with a true scope and spirit being indicated by the following claims.

1. A method comprising:
determining, by an application associated with a user device, that the user device is configured to use a randomized media access control (MAC) address;
generating, by the application, a unique identifier (ID) associated with the user device;
receiving, from at least one of a gateway device or a server device, an instruction to send the unique ID when the application sends at least one data packet to the at least one of the gateway device or the server device; and
sending, based on a request for data received by the application, the unique ID, a randomized MAC address, and data associated with the request.

2. The method of claim 1, wherein the user device is configured to determine a new randomized MAC address based on at least one of a trigger condition associated with the user device, an elapsed time since determining a previous MAC address, or an action taken by the user device.

3. The method of claim 1, wherein the application is downloaded on a user device.

4. The method of claim 1, wherein at least one of the gateway device or the server device are configured to determine the user device generates randomized MAC addresses.

5. The method of claim 1, wherein the at least one of the gateway device or the server device are configured to determine, based on the unique ID, an identity associated with the user device and disregard the MAC address.

6. The method of claim 1, wherein the MAC address is a first randomized MAC address, the request is a first request, and the data is first data associated with the first request, further comprising sending, based on a second request for data received by the application, the unique ID, a second randomized MAC address associated with the user device, and second data associated with the second request.

7. The method of claim 1, wherein the gateway device is located at a premises associated with the user device and the server device is located external to the premises.

8. A method comprising:
determining, by a gateway device, that a user device is configured to generate a randomized media access control (MAC) address;
sending, to an application associated with the user device, an instruction for the application to send a unique identifier (ID) associated with the user device when the application sends at least one data packet to the gateway device;
receiving, based on a request for data associated with the application, a randomized MAC address associated with the user device, the unique ID, and data associated with the request; and
sending, to a server device associated with at least one of the application or the gateway device, the unique ID and the data associated with the request.

9. The method of claim 8, wherein the gateway device is configured to generate the unique ID, and wherein the gateway device is further configured to send the unique ID to at least one of the application or the server device.

10. The method of claim 9, wherein the server device is configured to cause the unique ID to be stored in a database associated with the server device.

11. The method of claim 8, wherein the gateway device comprises a protocol configured to determine the unique ID received by the application.

12. The method of claim 8, further comprising determining, based on the unique ID, an identity associated with the user device, and wherein the gateway device is further configured to disregard the randomized MAC address received from the application.

13. The method of claim 8, wherein the MAC address is a first randomized MAC address, the request is a first request, and the data is first data associated with the first request, further comprising receiving, based on sending a second request for data to the application, the unique ID, a second randomized MAC address associated with the user device, and second data associated with the second request.

14. The method of claim 8, wherein the gateway device is located at a premises associated with the user device and the server device is located external to the premises.

15. A method comprising:
determining, by a server device, that a user device is configured to generate a randomized media access control (MAC) address;
causing sending, to an application associated with the user device, an instruction for the application to send a unique identifier (ID) associated with the user device when the application sends at least one data packet to at least one of a gateway device or the server device; and
receiving, based on a request for data associated with the application, a randomized MAC address, the unique ID, and data associated with the request.

16. The method of claim 15, wherein the server device is configured to generate the unique ID, and wherein the server device is further configured to send the unique ID to at least one of the application or the gateway device.

17. The method of claim 15, wherein the server device comprises a protocol configured to determine the unique ID received by the application.

18. The method of claim 15, further comprising determining, based on the unique ID, an identity associated with the user device, and wherein the server device is further configured to disregard the randomized MAC address received from the application.

19. The method of claim 15, wherein the MAC address is a first randomized MAC address, the request is a first request, and the data is first data associated with the first request, further comprising receiving, based on a second request for data associated with the application, the unique ID, a second randomized MAC address associated with the user device, and second data associated with the second request.

20. The method of claim 15, wherein the gateway device is located at a premises associated with the user device and the server device is located external to the premises.
